(19) United States
(12) Patent Application Publication
(10) Pub. No.: US 2006/0077757 A1
(43) Pub. Date: Apr. 13, 2006

(54) Apparatus and method for seismic measurement-while-drilling

(76) Inventors: Dale Cox, Ponca City, OK (US); David R. Hall, Provo, UT (US); H. Tracy Hall, Provo, UT (US); Joe R. Fox, Spanish Fork, UT (US)

Correspondence Address: David R. Hall, 2185 S Larsen Pkwy, Provo, UT, 84606, US

(21) Appl. No.: 10/965,563

(22) Filed: Oct. 13, 2004

(51) Int. Cl. G01V 1/00

(52) U.S. Cl. 367/25

(57) ABSTRACT

An apparatus and method for seismic measurement-while-drilling comprises at least one of a downhole seismic receiver or a downhole seismic source deployed in a telemetry drill string. Preferably both a downhole receiver and a downhole source are deployed in the drill string, the source and receiver being fixed at a pre-determined distance from each other. As drilling progresses into a subterranean formation, a first seismic shot is performed at a first level, producing a model characteristic of the subterranean formation, and at least one subsequent seismic shot is performed at at least one subsequent level, producing at least a second model characteristic of the subterranean formation. The first and at least the second model are used in combination to evaluate the subterranean formation and to evaluate the progress of the drill string relative to the formation.

### CROSS-REFERENCE TO RELATED APPLICATIONS

None

### FEDERAL SPONSORSHIP

None

### BACKGROUND OF THE INVENTION

This invention relates to an apparatus and method for seismic measurement-while-drilling (seismic MWD), preferably comprising a downhole transmission network integrated into a drill string.

An outstanding problem in the exploration for new hydrocarbons and in the development of known hydrocarbon reservoirs is determining the location of reflectors in subterranean formations. A reflector is any feature in the formation where there is a change in acoustic impedance. Examples of reflectors include boundaries between different sedimentary formations; faults, cracks, or cavities; zones permeated with different fluids or gases; and zones exhibiting a gradient in pore pressure.

In a surface seismic survey both sources and receivers are positioned at or near the surface. This is the most widely-used type of geophysical survey, but it is hampered by noise, interference, and attenuation that occur near the surface. The seismic source may be a mechanical wave generator, an explosive, or an air gun. It generates waves that reflect from the formations of interest and are detected by the receivers, which may incorporate sensors such as geophones, accelerometers, or hydrophones that measure phenomena such as velocity, acceleration, or fluid pressure. Seismic survey equipment synchronizes the sources and receivers, records a pilot signal representative of the source, and records reflected waveforms that are detected by the receivers. The data is processed to graphically display the time it takes seismic waves to travel between the surface and each subterranean reflector. If the velocity of seismic waves in each subterranean layer can be determined, the position of each reflector can then be established.

However, surface seismic data cannot provide the velocity data that is required for the transformation of the subsurface seismic map from the time domain to the spatial domain. The speed of sound in each region of the sub-surface must be obtained from seismic measurements performed in a borehole, typically by lowering instruments into the borehole on a wireline. One such technique, vertical seismic profiling (VSP), uses one or more sources at the surface with one or more receivers deployed in the borehole on a wireline. Reverse vertical seismic profiling (RVSP), also known as inverse seismic profiling (IVSP), uses receivers at the surface with a source deployed on a wireline. Such measurements may also be made in a borehole that deviates from the vertical. Wireline seismic surveys typically require lengthy and expensive interruption of the drilling process.

Also known in the art are means for obtaining seismic information from the borehole via tools incorporated as tubular components of the drill string. These methods are known collectively as seismic measurement-while-drilling (seismic MWD), sometimes shortened to “seismic while drilling”, because seismic data can be acquired without lengthy interruption of the drilling process.

A known method for RVSP MWD involves the use of a seismic source placed close to the drill bit with receivers positioned at or near the surface. U.S. Pat. No. 4,207,619 discloses use of a seismic pulse generator, such as a breakout jar, near the bit. A circularly-symmetric array of sensors is located around the well head at the surface. A reference or pilot sensor is located at the top of the drill string to obtain a waveform representative of the source. A seismic shot is performed at a first level, and travel times are obtained for refracted rays traveling from the source generally toward the receiver and for reflected rays traveling from the source to a reflector below the source and back to the receivers. As drilling progresses subsequent seismic levels are taken. By comparing refracted and reflected travel times at various levels, velocities for the various intervals in the formation can be obtained. U.S. Pat. Nos. 4,363,112 and 4,365,322 disclose methods for RVSP MWD using the drill bit itself as a seismic source. A zone that is saturated with gas will attenuate the seismic waves, causing a seismic shadow. A gas zone that has been bypassed by the existing well may be discovered by tracing rays between the bit and an array of surface receivers as the well is drilled to progressively deeper levels.

The chief obstacle to widespread use of RVSP MWD is the difficulty in obtaining an accurate source pilot signal for correlation with the signals obtained by the surface receivers. U.S. Pat. No. 4,718,048 teaches one method for correlation of a source pilot signal received at the top of the drill string with the signals received by surface receivers. Provision of a source pilot signal at the top of the string is hindered by two difficulties. First, the pilot signal from the source at the bottom of the drill string is highly attenuated, clipped, multiply reflected, and distorted during its long passage through the drill string. Secondly, noise generated by rotation and vibration of the string itself can overwhelm the source signal. U.S. Pat. No. 4,849,945 teaches means for correlating signals received from at least two different surface receivers without reference to a source pilot signal. U.S. Pat. No. 5,012,453 also discloses a method for producing a reverse vertical seismic profile with as few as one receiver without reference to a pilot signal. The method depends only on knowing the relative arrival times at the sensor of the direct waves and the secondary reflectance waves. Seismic processing methods that seek to eliminate the need for a direct source pilot signal require a strong and distinct direct wave, which is not always available.

RVSP MWD techniques that employ the drill bit as the source are generally limited to use of roller bits in hard formations, because shear bits, which are widely used in softer formations, generally do not provide a sufficient impulse for detection after being attenuated by poorly-consolidated near-surface formations. A jar can provide a much stronger signal than a bit, as is taught by the '619 patent. U.S. Pat. No. 4,873,675 also teaches use of a jar as a source, with provision of a pilot signal via a hydrophone positioned near the bit. It also teaches suppression of tube waves by use of a telescoping joint above the jar. A telemetry cable must run the length of the drill string from the surface to the hydrophone. Provision of a wireline for the pilot signal may interrupt the drilling process as severely as does a wireline seismic survey.

The principle of reciprocity in geophysics allows sources and receivers to be interchanged within the same analytical framework. Thus RVSP MWD and VSP MWD are equally possible, provided that the source and receiver signals for each technique have equivalent quality when the devices are interchanged. In practice it is usually convenient to employ more receivers than sources, and the wide dynamic range and complexity of the waveforms generated from multiple reflectors in the formation generally require a receiver to collect and transmit much more information than is required for a source pilot signal. Accordingly, the deployment of receivers in the drill string for VSP MWD has generally been limited by the low bandwidth of existing downhole telemetry systems. It would be very desirable to employ receivers downhole for seismic MWD measurements. This would place the receiver far from noise associated with drilling equipment and cultural activity at the surface, would avoid the attenuation and the complexity of reflectors in unconsolidated near-surface formations, and would position the receivers much closer to the target of interest.

U.S. Pat. No. 5,585,556 discloses a method and apparatus for performing VSP MWD measurements with a downhole receiver. A seismic source is used at or near the surface, and a receiver in the bottom-hole assembly (BHA) is provided with a memory and calculation device for storing and processing the seismic signals. The technique requires that a chronometer at the surface be synchronized with a chronometer in the downhole tool to within 1 millisecond over the duration of the drilling operation, which can continue for many days. The downhole receiver should be activated during pauses in circulation and rotation, although means for activating the receiver are not disclosed. The downhole memory and calculation unit stores the recorded waveforms and processes them to obtain the direct arrival. This result is then sent to the surface via mud pulse telemetry while drilling ahead. Because the complete waveform, which is required for detecting reflections, can only be recovered after the receiver is retrieved to the surface, only a partial seismic data set—the seismic velocity as a function of depth, is acquired while drilling. This enables transformation of the surface seismic model from the time domain to the spatial domain, but identification of approaching or receding reflectors can only be made after the tool is tripped out of hole—often too late to take corrective action. U.S. Pat. No. 6,308,137 teaches a means for activating a downhole receiver by detecting cessation of rotation and circulation, followed by detection and recognition of a pre-established sequence of seismic impulses sent by a surface source. It would be much more desirable to command, control, and synchronize a downhole receiver by means of an integrated downhole transmission network and to obtain the received waveforms at the surface in real time, while drilling.

All known VSP MWD techniques require that the source be located at the surface. By the principal of reciprocity, a surface source suffers the same limitations as a surface receiver. The source wave will suffer high attenuation, distortion, surface-directed refraction, scattering from unknown surface reflectors, and interference from rig noise and cultural activities. Accordingly, it would be desirable to place both a source and a receiver in the borehole, away from surface interference. This can only be facilitated by a high-speed, real-time downhole data transmission system.

U.S. Pat. No. 6,670,880, “Downhole Data Transmission System,” which is incorporated herein by reference, discloses the preferred drill pipe telemetry system for the present invention. It provides the high data rates needed for seismic surveys via elements that are incorporated in standard double-shoulder drilling tubulars that are joined via standard rig floor operations. The system is transparent to nearly all existing drilling operations. It is capable of actuating downhole seismic sources and receivers and provides means for communicating, in real time, large amounts of data to and from a variety of downhole tools. Thereby it becomes possible to transmit complete waveforms received downhole, to transmit accurate pilot signals from downhole sources, and to precisely synchronize sources and receivers without need for highly accurate downhole chronometers. This system enables a variety of seismic MWD measurements using sources and receivers that are positioned deep downhole, far from surface interference and close to the target of interest.

### SUMMARY OF THE INVENTION

An apparatus and method for seismic measurement-while drilling comprises at least one of a downhole seismic receiver or a downhole seismic source deployed in a drill string. Preferably both a downhole receiver and a downhole source are deployed in the drill string, the source and receiver being fixed at a pre-determined distance from each other. Alternatively, a surface source may be used together with a downhole receiver deployed in the drill string, or a surface receiver may be used together with a downhole source deployed in the drill string. As drilling progresses into a subterranean formation, a first seismic shot is performed at a first level, producing a model characteristic of the subterranean formation, and at least one subsequent seismic shot is performed at at least one subsequent level, producing at least a second model characteristic of the subterranean formation. The first and at least the second model are used in combination to evaluate the subterranean formation and to evaluate the progress of the drill string relative to the formation. The downhole seismic source may comprise a mud hammer, a mud siren, a jar, a piezoelectric source, a magnetostrictive element, an eccentric rotor, or a drill bit. The downhole seismic receiver may comprise a geophone, a hydrophone, or an accelerometer. Preferably the drill string comprises an integrated downhole transmission network capable of transmitting data signals.

When a source is deployed in the drill string, it is preferred that a pilot signal representative of the source is transmitted in real time to the surface over the downhole network. When a receiver is deployed in the drill string, the detected waveforms are preferably transmitted in real time to the surface over the downhole network. Downhole tools are preferably correlated in time with each other (synchronized) by means of the downhole network and are synchronized with any surface tools by means of a surface network that is connected to the downhole network. The surface network may comprise any known means for communication of signals between discrete devices, such as direct electrical connections or wireless connections such as light waves, microwaves, or radio waves. Preferably the surface network also comprises means for precise time synchronization of surface devices. In the preferred embodiment, the downhole data transmission network comprises means disclosed in the '880 patent.

In one preferred embodiment the seismic source comprises a mud-actuated hammer. Whatever source is used, it preferably produces a characteristic wave that enables the source signal to be readily differentiated from noise generated by the drill string.

A tube wave suppression device may be positioned between the source and the receiver to eliminate or suppress tube waves that are guided along the borehole between the source and the receiver.

A seismic level is preferably acquired during a natural pause in drilling, when rotation and circulation have ceased. Alternatively, a seismic level may be acquired when rotation and active drilling have stopped, but while maintaining circulation.

In one embodiment of the present invention, multiple sources and receivers may be employed. The receivers may be positioned below the sources (VSP), above the sources (RSVP), alternating with sources, or in any other possible combination. In the most general embodiment of the present invention, any combination of sources and receivers may be deployed both at the surface and in the drill string, with at least one of a pilot signal from a downhole source or a waveform from a downhole receiver being communicated over the integrated downhole data network.

### BRIEF DESCRIPTION OF THE FIGURES

FIG. 1 is a cross section of the preferred embodiment of the invention for RVSP MWD.

FIG. 2 is a cross section of an embodiment of the invention for drill-bit seismic MWD.

FIG. 3 is a cross section of the most general embodiment of the invention.

FIG. 4 is a perspective cross section of two adjacent joints in the preferred enablement of an integrated transmission network that facilitates the invention.

FIG. 5 is a flow chart illustrating the method according to the invention for determining the location of a subterranean formation and the location of the bit with respect to the formation.

FIG. 6 is a model of a section of the earth showing seismic velocity with respect to depth.

FIG. 7a is a model of surface seismic ray paths consistent with the velocities presented in FIG. 6.

FIG. 7b is a model of surface seismic waveforms consistent with the models of FIG. 6 and FIG. 7a.

FIGS. 8a and 8b are models of borehole seismic ray paths produced in an upper zone and in a lower zone, respectively, of a borehole, according to the preferred embodiment of FIG. 1.

FIG. 9a is a model presenting borehole seismic waveforms received according to the embodiment of FIG. 1.

FIGS. 9b and 9c repeat the surface seismic waveforms of FIG. 7b to facilitate correlation with the borehole seismic waveforms of FIG. 9a.

FIG. 10 is a graph that correlates the waveforms of FIG. 9a with the ray paths of FIGS. 8a and 8b along a common depth axis.

FIG. 11a is a graph that isolates the up-going events from FIG. 9a and aligns them in time. FIG. 11b is a graph that isolates the down-going events from FIG. 9a and aligns them in time. FIG. 12a is a graph that combines the up-going and down-going waveforms of FIGS. 11a and 11b and shows the time-to-depth curve.

FIG. 12b repeats the surface seismic waveforms of FIG. 7b to facilitate correlation with FIG. 12a.

FIG. 13a is a graph that models borehole tube waveforms.

FIG. 13b is a graph that superimposes the tube waves of FIG. 13a on the borehole seismic waveforms of FIG. 9a.

FIG. 14 repeats the earth model of FIG. 6 and compares the velocity curve used in the modeling with the velocity curve calculated from the time-to-depth curve of FIG. 12a.

FIG. 15a is a graph presenting the trajectory of a borehole that goes from nearly vertical to nearly horizontal.

FIG. 15b is a graph that models seismic waveforms received from successive levels according to the embodiment of FIG. 1 as a well progresses from the nearly vertical section of FIG. 15a to the nearly horizontal section of FIG. 15a.

FIG. 15c is a graph showing the depth of each seismic level in FIG. 15b.

FIG. 15d repeats the surface seismic waveforms of FIG. 7b to facilitate correlation with the borehole seismic waveforms of FIG. 15b.

### DESCRIPTION OF THE PREFERRED EMBODIMENTS

The disclosed description is meant to illustrate the present invention and not to limit its scope; other embodiments of the present invention are possible within the scope and spirit of the claims. Examples 1 through 8 disclose various arrangements of sources and receivers for borehole seismic MWD according to the invention. Seismic processing methods relevant to these configurations are then disclosed.

### EXAMPLE 1

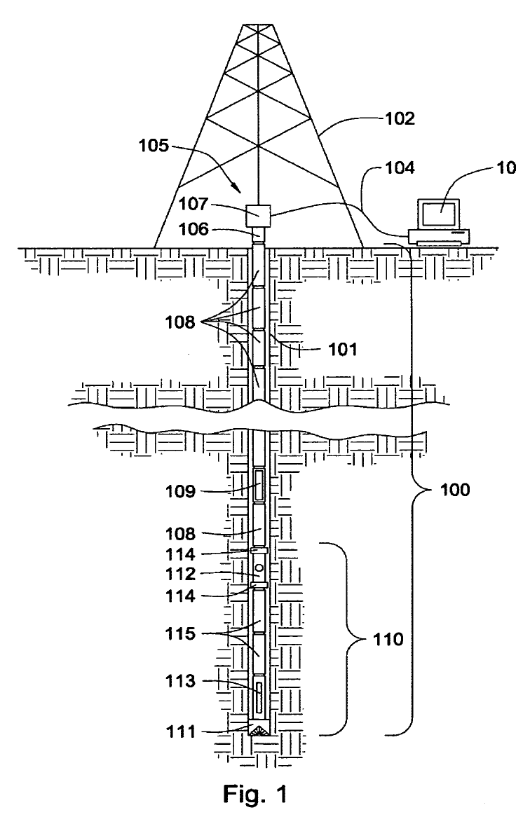

FIG. 1 shows a cross section of the preferred embodiment of the invention for RVSP MWD. A drill string 100, comprising an integrated data transmission network, is suspended in a well bore 101 from a derrick 102. Surface equipment 103, such as a computer, connects via a cable 104 to a data saver 105. The data saver is adapted to transmit data to and from the downhole portion of the integrated transmission network while the drill string is rotating and progressing forward into the earth. It may comprise an element 106 that rotates with the drill string and an element 107 that does not rotate and connects to the cable 104. The data saver may comprise means for transferring information through a rotating joint, such as a slip ring or an inductive coupler. To avoid need for the cable 104, the data saver may communicate with the surface equipment by wireless means, such as by infrared waves, microwaves, or radio waves, in which case the entire data saver may rotate with the drill string. The data saver may also serve as a “saver sub” to protect the threads of the uppermost rotary drive element (not shown) from which it is suspended. The data saver may be a passive device that allows transmission of data in both directions, or it may incorporate a data link having active circuits that communicate a fresh signal in each direction. A data saver comprising a data link may incorporate functions such as signal level detection, signal amplification, error correction, and integration with physical data sensors. The physical data sensors in the data saver may serve to measure top-hole parameters such as rate of rotation, torque, flow, pressure, hook weight, and orientation.

The network is facilitated by incorporated elements of an integrated data transmission system into every element in the drill string 100. Elements included in the drill string may include telemetry drill pipes 108, data links or repeaters 109, and a bottom-hole assembly (BHA) 110. Telemetry drill pipes 108 are passive elements that pass the network signal in both directions. Data links 109 are distributed at appropriate intervals along the drill string. These active elements serve to receive the data signal and to retransmit it at full strength in both directions. The data links may also comprise error-correction circuitry and means for connecting and communicating with various tools that may be integrated with a link or positioned near a link. Tools that may be integrated with a link or positioned near a link may include service tools, such as MWD tools, logging-while-drilling (LWD) tools, rotary-steerable tools, seismic sources, or seismic receivers. The data links may also provide any of a number of services to a connected service tool, such as communication and power. The data links themselves may also comprise a variety of sensors for downhole conditions. The bottom-hole assembly 110 may comprise any selection and combination of elements 115 such as heavy-weight pipe, drill collars, stabilizers, reamers, mud motors, rotary-steerable systems, jars, imaging devices, MWD tools, and LWD tools, provided that the data telemetry network is integrated into each tool. In some cases it may even be desirable to place sensors directly in the bit 111, in which case the downhole network terminates in the drill bit. In other instances the downhole network would terminate in the lowest element or tool with which communication is desired.

Downhole service tools have traditionally been incorporated only in the bottom-hole assembly, because data from all such tools must be fed to a single mud pulse tool that is placed at the top of the BHA and which communicates with the surface. Utilization of an integrated data transmission drill string allows service tools to be distributed anywhere along the string. Distributed service tools may, for instance, monitor pressure and temperature gradients along the drill string or may monitor drill string dynamics. A drill string comprising an integrated data telemetry network presents particular advantages for borehole VSP MWD or RVSP MWD, because sources and receivers can be deployed anywhere in the string.

In the preferred embodiment of FIG. 1 at least one downhole seismic receiver 112 is placed a fixed distance from at least one downhole seismic source 113. Preferably the receiver is placed above the source, but in certain applications it may be desirable to place the source above the receiver. Most preferably the receiver and source are both located in the BHA 110. The source may comprise any known source of seismic waves, such as a mud hammer, a mud siren, a drilling jar, an eccentric rotor, a piezoelectric stack, a magnetostrictive actuator, or an actively-drilling drill bit, in which case element 113 may be considered to be integral with the bit 111. Preferably the source 113 is placed close to the drill bit 111 and is coupled to the formation through the bit. Alternatively, the source may be coupled directly with the borehole 101 by placing it in contact with the borehole wall. Placement against the borehole wall may be accomplished by passive means, such as by placing the source in a stabilizer or reamer having a diameter equal to the borehole, or by providing springs to hold the source against the wall. Alternatively the source may be placed against the borehole wall upon command from surface equipment 103 over the telemetry drill string 100, using an actuator driven by electrical or hydraulic means. The source may also be spaced away from the borehole wall 101 and coupled to it through the drilling mud.

Most preferably the source 113 is a mud-actuated hammer, such as is disclosed in U.S. Pat. No. 5,396,965, which is incorporated herein by reference. Preferably the mud hammer couples to the formation through the bit. Alternatively, the mud hammer may couple to the formation through the mud, in which case the bit may be raised off bottom during a seismic shot. Preferably the mud hammer is equipped with pilot sensors that send data to the surface that is representative of the seismic waves generated by the hammer. The preferred pilot sensor is a three-axis accelerometer mounted in the hammer.

The receiver 112 may comprise a transducer selected from the group consisting of a geophone, a hydrophone, and an accelerometer. The receiver may couple to the formation through the drill bit and intervening elements in the BHA. Alternatively it may be coupled directly to the borehole wall. Placement of the receiving transducer against the borehole wall 101 may be accomplished by passive means, such as by placing the receiver in a stabilizer or reamer having a diameter equal to the borehole, or by providing springs to hold the receiving element against the borehole wall. Alternatively the receiving element may be placed against the borehole wall upon command from surface equipment 103 over the telemetry drill string 100, using an actuator driven by electrical or hydraulic means. The receiver may also be spaced away from the borehole wall 101 and may couple to it through the drilling mud, in which case the receiver preferably comprises a hydrophone.

One or more tube wave suppression devices 114 may be positioned in the drill string to eliminate or attenuate tube waves that are guided along the borehole. Preferably at least one tube wave suppressor is placed between the source and the receiver. Most preferably at least two tube wave suppressors are employed, one positioned above the receiver, and the other positioned below the receiver. One such device is disclosed by U.S. Pat. No. 6,196,350, which is incorporated herein by reference. The '350 patent also discusses several other means for tube wave suppression, from column 1, line 58, through column 3, line 37. Another means for tube wave suppression, disclosed by Milligan et. al., in Geophysics, V. 62, pp. 842-852 (May-June 1997), employs closed-cell foam baffles positioned between sources and receivers. Tube wave suppression devices have heretofore been intended primarily for deployment on a wireline, but most such devices can be readily adapted for incorporation in a telemetry drill string. The tube wave suppressor may be a passive device that functions continuously, but preferably it is one having an active mode that is commanded from surface equipment 103 over the telemetry drill string 100.

### EXAMPLE 2

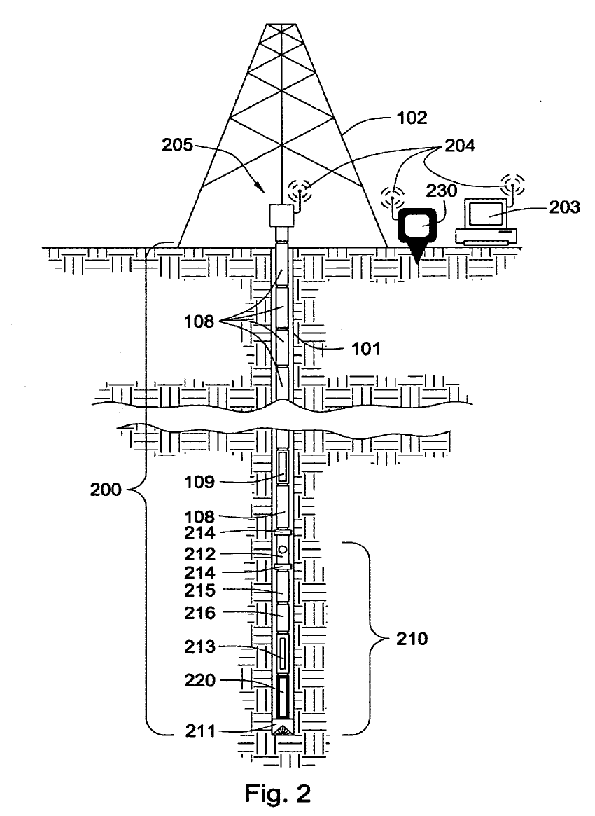

FIG. 2 illustrates an embodiment of the invention for drill-bit seismic MWD, wherein an actively-drilling bit 211 serves as the seismic source. The telemetry drill string 200 may comprise many of the same elements as string 100 of FIG. 1, and certain of the elements 101 through 109 are retained in FIG. 2. However, the BHA 210 will be configured in a different manner. As the bit disintegrates the formation it induces seismic waves therein. As the formation disintegrates, it pushes back on the cutters of the bit with reactive impulses that are characteristic of the induced seismic waves. These impulses are transmitted through the bit to a bit pilot signal tool 220 that comprises the lowest or terminal member of the data transmission system 200. The bit pilot tool preferably comprises an accelerometer, most preferably a three-axis accelerometer. It may also comprise other sensors that respond to strain, pressure, or motion in the near-bit region of the BHA, such as weight-on-bit sensors, three-axis strain gauges, torsion strain gauges, pressure sensors, geophones, or hydrophones.

The bit pilot sensor 220 may also be physically integrated directly into the bit 211; in which case the single unit 220/221 may be referred to as an integrated seismic pilot drill bit. The pilot sensor sends data representative of the bit pilot signal over the telemetry drill string 200 to the surface. The activity of the drill bit 211 may be augmented by a mud hammer 213 that is placed near the bit in the BHA, in which case hammer 213, pilot sensor 220, and bit 211 may be thought of as a single integrated seismic source. The mud hammer may have its own built-in pilot sensors, and data from these sensors may be simultaneously sent to the surface to supplement the bit pilot signal.

A seismic receiver 212 may be incorporated in the BHA 210, as well as tube wave suppressors 214. The BHA may also incorporate other elements, not shown, such as drill collars, stabilizers, reamers, a jar, and various MWD and LWD tools. A mud motor 215 may be incorporated in the BHA, and optionally also a rotary steering tool 216. When a mud motor is employed, the portion of the drill string above the motor will not usually be rotating, or it may require only slow rotation, in which case the environment in the portion of the borehole above the mud motor may then be sufficiently quiet to enable the in-string receiver 212 to function properly. The receiver 212 may be positioned a considerable distance above the motor 215, and it may be desirable to employ shock absorbers, not shown, between the receiver and the motor.

If no motor is employed, or if a bent sub (not shown) is included in the BHA and the bit is required to drill straight ahead, then the entire string must rotate in order to advance the bit in a straight line into the formation. When the entire string is rotating, it is probable that vibrations from the drill string will overwhelm the weak vibrations induced by seismic reflections traveling from reflectors to the borehole wall 101, thereby making it impossible to extract the weak seismic signal from the waveforms received and sent to the surface by the receiver 212. Accordingly, in this embodiment of the invention, it is preferred to employ at least one receiver 230 at or near the surface.

In this example, data saver 205, receiver 230, and surface computing and control equipment 203 are interconnected by wireless means 204; however, cables may alternatively be used. Surface elements 205, 230, and 203 may comprise nodes on any known form of wireless communication network, such as a network conforming to the IEEE 802.11 standard. When a motor 215 is employed and the upper portion of the drill string is not rotating, data from the downhole receiver 212 may optionally be used to supplement data from the surface receiver 230.

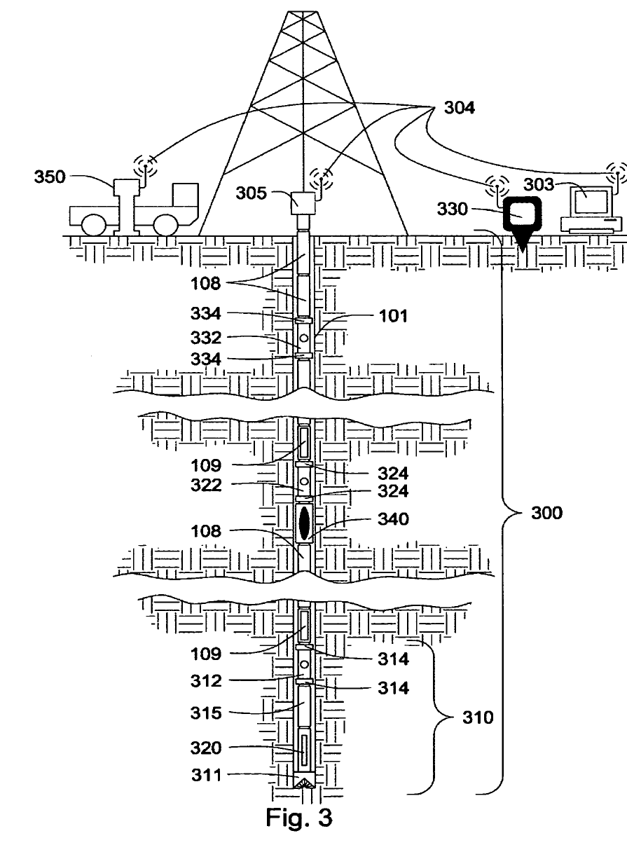

FIG. 3 illustrates the most general embodiment of the present invention. Certain of the elements 101 through 109 have been retained from FIG. 1. As drilling progresses into the earth, the drill string may pass through formations having widely varying physical properties. With an appropriate configuration of borehole and surface tools, an optimum seismic-while drilling program may be devised for any of a variety of down-hole conditions by selecting the best combination of surface and borehole sources and surface and borehole receivers. In each case at least one of a pilot signal from a downhole source or a waveform from a downhole receiver will be transmitted in real time to the surface over the integrated downhole transmission network 300. The control and data communication capabilities of the telemetry drill string enable a wide variety of seismic experiments to be conducted in a single assembly without tripping out of hole to reconfigure sources or receivers. Any possible combination of downhole sources and receivers may be deployed, either in the BHA 310 or distributed elsewhere along the drill string 300, together with any possible combination of surface sources and receivers, all selected and controlled from surface equipment 303. The BHA 310 may comprise any selection and combination of elements such as heavy-weight pipe, drill collars, stabilizers, reamers, mud motors, rotary-steerable systems, jars, imaging devices, MWD tools, and LWD tools, provided that the data telemetry network is integrated into each tool. The BHA may also comprise a source 320, together with tube wave suppression devices 314, and a receiver 312. Bit 311 may itself incorporate sensors and circuitry for communicating a bit pilot signal. One or more additional sources 340, receivers 322, 332, and tube wave suppression devices 324, 334 may be deployed at positions up-hole from the BHA. A surface source 350 may also be deployed, as well as a surface receiver 330. In this example surface computing equipment 303 communicates with data saver 305, source 350, and receiver 330 by wireless means 304. Alternatively cables, not shown, may be substituted for the wireless means. Preferably surface elements 303, 305, 330, and 350 comprise nodes on a known implementation of a wireless data communication network.

### EXAMPLE 3

Referring to FIG. 3, the downhole source 320 is a mud hammer that is controlled from the surface over the telemetry drill string 300. Source 320 also sends a pilot signal to surface equipment 303 over the downhole and surface networks. Downhole seismic receiver 312 is activated from the surface and sends its received waveforms to the surface over the telemetry drill string 300. If receiver 312 contains active means for positioning the seismic sensor against the borehole wall, this means is also activated and controlled from the surface. If the tube wave suppression devices 314 require activation, this, too, is commanded over the drill string from the surface. In this embodiment the drill string 300 is not rotating, but mud is circulated to drive the hammer. All other elements shown remain physically in place, with all downhole elements serving as part of the telemetry drill string, but the seismic functions of these other elements are not active. Thus, by selective command and control from the surface, the most preferred embodiment of Example 1, FIG. 1, for RVSP MWD is duplicated.

### EXAMPLE 4

The mechanical configuration of FIG. 3 is retained, but the surface computer 303 activates a different set of surface and borehole tools. The drill string 300 continues to drill actively forward during the experiment, with bit 311 serving as the seismic source. The pilot sensors in the bit 311 may be used to provide the bit pilot signal to surface equipment 303 over the telemetry drill string 300. Mud hammer 320 may be also be activated from the surface to augment the seismic and drilling activity of the bit, and pilot sensors in the hammer may be used to augment the pilot signal from the bit 311. (Hammer augmentation may be particularly desired while drilling in soft formations with a shear bit.) The surface receiver 330 is simultaneously activated on command from computer 303. Surface source 350 and mid-string source 340 are not active. If in-string receivers 312, 322 and 332 are not active, the drill-bit seismic experiment of Example 2, FIG. 2 is duplicated. If a mud motor 315 has been installed in the BHA below the receivers, and if the portion of the string 300 above the motor 315 is not rotating, receivers 312, 322, and 332 may then be actuated to augment the information received by the surface receiver 3300, in which case tube wave suppression devices 314, 324, and 334 are preferably also active.

### EXAMPLE 5

While retaining the mechanical configuration of FIG. 3, rotation and circulation are stopped, and down-hole receivers 312, 322, and 332 are activated by commands sent from the surface computer 303 over the telemetry drill string 300. Tube wave suppressors 314, 324, and 334 are also activated. Surface receiver 330 and downhole sources 320 and 340 are inactive. Surface source 350 is then activated by computer 303. Thereby a conventional VSP seismic experiment is enabled while drilling. If a sufficient number of additional mid-string receivers, not shown, are also deployed, a typical wireline VSP experiment could be exactly duplicated at a single drill depth. However, the present invention enables an arbitrary number of closely-spaced sequential VSP levels to be obtained while drilling without need to deploy a large number of in-string receivers.

### EXAMPLE 6

While retaining the mechanical configuration of FIG. 3, rotation is stopped while circulation is maintained. The bit is left on bottom. Downhole mud-hammer source 320 is actuated, as is surface receiver 330. Pilot signals representative of the seismic signal are sent from the source 320 to the surface over the telemetry drill string 300. Surface source 350, downhole source 340, and downhole receivers 312, 322, and 332 are inactivate. A conventional RVSP experiment is thereby enabled while drilling.

### EXAMPLE 7

While retaining the mechanical configuration of FIG. 3, rotation is stopped. Source 340, which is relatively high in the drill string, is enabled; borehole receivers 312, 322, and 332 are enabled, together with downhole tube wave suppressors 314, 324, and 334; and surface receiver 330 is also enabled. Pilot signals from source 314 and received waveforms from receivers 312, 322, and 332 are sent to the surface over telemetry drill string 300. Downhole source 320 and surface source 350 are inactive. This particular combination of source and receivers may provide an enhanced perspective of formations lying between the uphole source 340 and the bit 311 and may provide information about hydrocarbon sources that may have been bypassed during the drilling operation.

### EXAMPLE 8

Any of examples 1, 2, 3, 4, 6, and 7, each of which employs at least one source in the borehole, is repeated. Additionally, receivers are activated that are positioned in a nearby well (not shown). The receivers in the nearby well are connected by means (not shown) to surface equipment 303. Pilot signals from the borehole sources and waveforms received by borehole receivers are communicated over the borehole telemetry system 300 to the surface equipment. Thereby a variety of cross-well seismic MWD experiments are enabled.

Features of the Invention Common to Preferred Embodiments

The remainder of this disclosure, while directed specifically to the configuration of the most preferred embodiment of Example 1, applies also to Examples 2 through 8, as well as to other embodiments of seismic MWD that are within the scope of the claims.

To enable real-time seismic measurement while drilling, including the embodiments of examples 1 through 8, the integrated downhole network should be capable of transmitting data at a rate exceeding 1,000 bits per second. More preferably the data rate should be in the range of 10,000 to 100,000 bits per second. Most preferable the data rate should be of the order of 1,000,000 bits per second. The downhole network should enable synchronization of the downhole and surface seismic devices to within 1 millisecond. More preferably, synchronization should be to within 100 microseconds, most preferably it should be to within one microsecond. The interconnections within the surface network and between the surface network and the downhole network should facilitate similar data rates and precision of synchronization.

Preferably the integrated downhole transmission network is capable of transmitting data signals both up and down the drill string. The network should enable control of downhole sources and receivers from the surface and real-time communication of data from these tools to the surface. This eliminates the need for down-hole data processing while enabling sophisticated real-time processing at the surface to obtain a model of the formation while drilling.

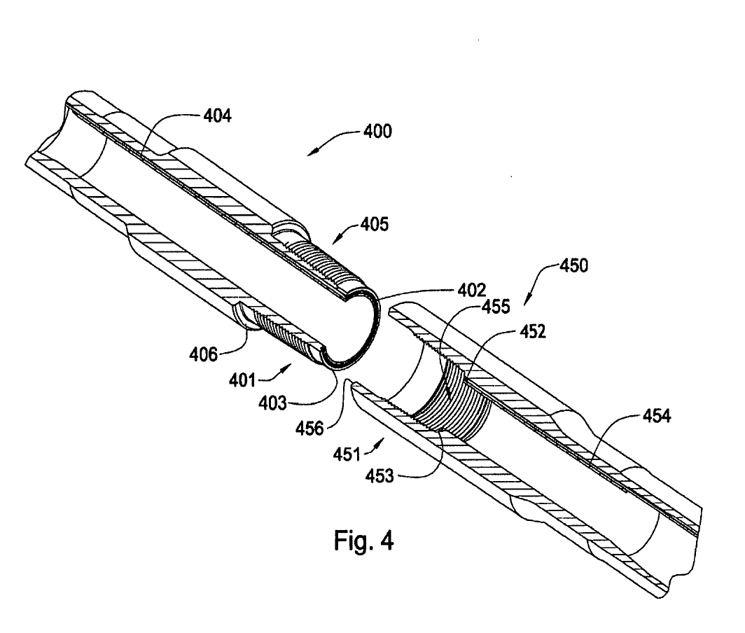

The preferred integrated downhole data transmission network is that disclosed in the '880 patent. For reference, the essential elements of the '880 telemetry drill string are illustrated in FIG. 4, which is a perspective cross section of two adjacent joints of components 400, 450. The components 400, 450 may comprise any element in the tool string 100, 200, 300 of FIGS. 1, 2, and 3, respectively. The pin end 401 of component 400 connects with the box end 451 of component 450. The box end, not shown, of component 400 is essentially identical to box end 451 of component 450, and the pin end, not shown, of component 450 is essentially identical to the pin end 401 of component 400. The components comprise data transmission element 402, located in the secondary shoulder 403 of pin end 401, and data transmission element 452, located in the secondary shoulder 453 of box end 451. The transmission elements 402, 452 each comprise a magnetically-conductive, electrically-insulating (MCEI) circular trough which is disposed in an annular groove formed in the secondary shoulders 403, 453. The MCEI trough preferably comprises an easily magnetizable and easily de-magnetizable material, most preferably a ferrite. The data transmission element 402 is connected to a similar data transmission element (not shown) at the box end of component 400 by means an electrical conductor 404, and the data transmission element 452 is connected to a similar data transmission element (not shown) at the pin end of component 450 by means of an electrical conductor 454. The electrical conductor 404, 454 is preferably a coaxial cable, most preferably a coaxial cable housed within a strong protective conduit. Certain components, such as jars and motors, may have additional means, not shown, for conducting the signal through an extensible region, through a rotating region, or through some other feature that prevents direct placement of a cable along the interior wall of the tool.

Joint makeup is facilitated by means of a threaded portion 405 located between the primary shoulder 406 and secondary shoulder 403 of the pin end 401, which engages a threaded portion 455 located between the primary shoulder 456 and secondary shoulder 453 of the box end 451. When the components of the drill string are made up, elements 402 and 452 are brought in close contact with each to form a closed magnetic path that facilitates data transmission between the elements.

Although telemetry drill string of the '880 patent is preferred, the present invention may also employ any other known implementation of a telemetry drill string, such as those employing other means for inductive coupling or means for direct electrical coupling. The present invention may also employ other known means for communicating between the surface and downhole components while drilling, such as wireline communication, mud pulse telemetry, drill pipe acoustic telemetry, and low frequency radio wave telemetry. Because of their generally low data rates, however, such means are not generally preferred.

Whatever means of data telemetry are employed, it is preferred in the present invention that at least one of a downhole seismic source or a downhole seismic receiver is deployed in the drill string and that a data stream representative of either the downhole source pilot signal or of the downhole received waveform signal is transmitted to the surface in real time. For purposes of this disclosure, “real time” means information that is sent without significant interruption of normal drilling procedures. It can refer either to information that is sent immediately upon detection, or to information that is stored temporarily downhole and relayed to the surface while drilling ahead from one seismic level to the next.

In the case of drill bit seismic MWD performed without downhole receivers, as in examples 2 and 4, where the drill bit provides the seismic source while drilling ahead, it is preferred that a pilot source representative of the source signal be transmitted over the network. However, it may be possible to provide a source that produces a characteristic wave that can be readily differentiated from noise generated by the drill string. Accordingly, in drill bit seismic embodiments according to the invention it may not always be necessary for a pilot signal to be sent over the drill string.

A seismic level is a set of seismic measurements taken at a given depth position, or if taken while actively drilling ahead, it is a set of seismic measurements taken over a narrow depth interval. A shot may comprise a single impulse from a seismic source such as a mud hammer impact or a jar firing, or it may comprise a waveform generated over a defined time interval, such as a swept frequency impulse (chirp) or a sequence of impulses emanating from a drill bit. Although a seismic level may consist of a single shot, it is preferred to stack several seismic shots that are performed at a single depth to enable a reduction in random or ambient noise.

In every embodiment of the present invention it is necessary to acquire at least two seismic levels at two different depths. As drilling progresses into the subterranean formation, a first seismic shot is performed at a first level, producing a model characteristic of the subterranean formation, and at least one subsequent seismic shot is performed at at least one subsequent level, producing at least a second model characteristic of the subterranean formation. The first and at least the second model are used in combination to evaluate the subterranean formation and to evaluate the progress of the drill string relative to the formation. The first and subsequent models will typically involve identification of subterranean reflectors. The first model identifies the time that it takes for a seismic wave to arrive at the receiver from one or more given reflectors. The second model identifies the arrival times of reflections from the same reflectors. If the drill string advances into the subterranean formation between the first and second levels, a later arrival time in the second model indicates that a given reflector is further away from the receiver and is therefore above the receiver. An earlier arrival time in the second model indicates that the reflector is closer to the receiver and is therefore below the receiver.

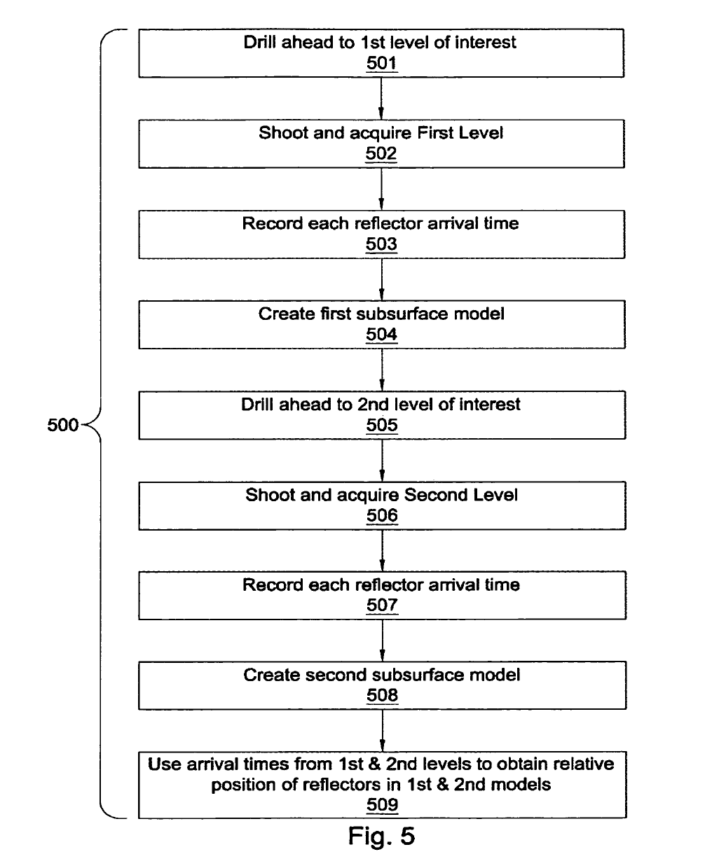

FIG. 5 presents a flow chart 500 illustrating the essential steps for seismic MWD according to the present invention, comprising steps 501 through 509. In step 501, the well is drilled ahead to a first level of seismic interest, preferably below unconsolidated surface rubble. In step 502, a first seismic level is obtained. Although the level may comprise a single seismic shot, a stack of repeated shots is preferred. Seismic body waves travel from the source through the earth, are reflected from interfaces in the earth, and arrive at a receiver, where the reflected waveform is acquired, transmitted to the surface computation equipment, and recorded. In step 503, the arrival time relative to source initiation for each reflector is recorded. In step 504, a model of the subsurface is created via computations on equipment located at the surface that derive from correlation of the source pilot signal (or a known source characteristic signal) with the received reflected waveforms. The first model will give the relative position, in the time domain, of at least one reflector relative to either the downhole source or the downhole receiver, but it may not necessarily indicate whether or not the reflector is above or below the source or receiver. In step 505, drilling continues for an appropriate interval and a second seismic level is taken (step 506). The time of arrival of each reflector is recorded in step 507, and second model of the subsurface is created (step 508).

In step 509, the time to each reflector for the first level is then compared with the time to each reflector for the second level. If, for a given reflector, the arrival time recorded in step 507 is greater than the arrival time recorded in step 503, then the source or receiver in the drill string has moved away from the reflector, and the reflector identified in the model of step 504 was above the source or receiver. If, for a given reflector, the time recorded in step 507 is less than the time recorded in step 503, then drilling has moved the source or receiver (or both source and receiver) toward the reflector, and the reflector identified in step 504 was below the source or receiver. From the known position of the source or receiver and the known distance from the first level to the second level, the average seismic velocity of the formation between the source and the receiver can be obtained, and the absolute seismic velocity in the interval drilled can be obtained. In this way a transformation from the time domain to the spatial domain is enabled. By repeated application of steps 501 through 509, increasingly greater precision in guiding the borehole to the targeted reflector can be obtained. Preferably many seismic levels will be performed as the drill string advances toward the target.

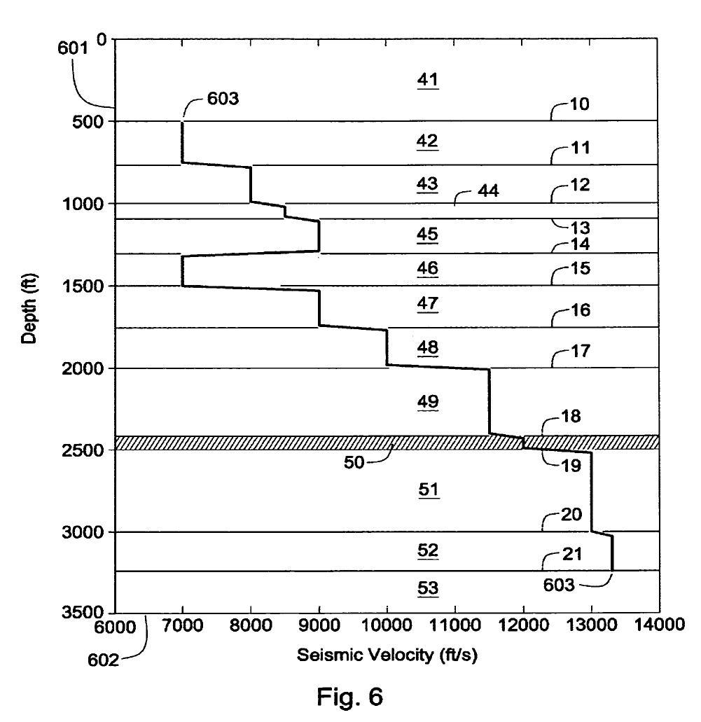

FIGS. 6 through 15 illustrate seismic processing according to the apparatus and method of the invention. FIG. 6 is a model of seismic velocity with respect to depth in the earth for a hypothetical location. Formations are numbered 41 through 53. Horizontal lines 10 through 21 represent reflectors or boundaries between the different formations. Line 603 gives the velocity of seismic body waves in each layer or formation 42 through 52. The depth of each reflector, in feet, is found on vertical axis 601. The velocity of a given layer, in feet per second, is found on horizontal axis 602. Thus the seismic velocity in formation 42 is about 7,000 feet per second, the seismic velocity in formation 48 is about 10,000 feet per second, and the velocity in formation 50 is about 12,000 feet per second. Formation 50, an oil or gas-bearing layer lying between reflectors 18 and 19 represents the target for a representative drilling program.

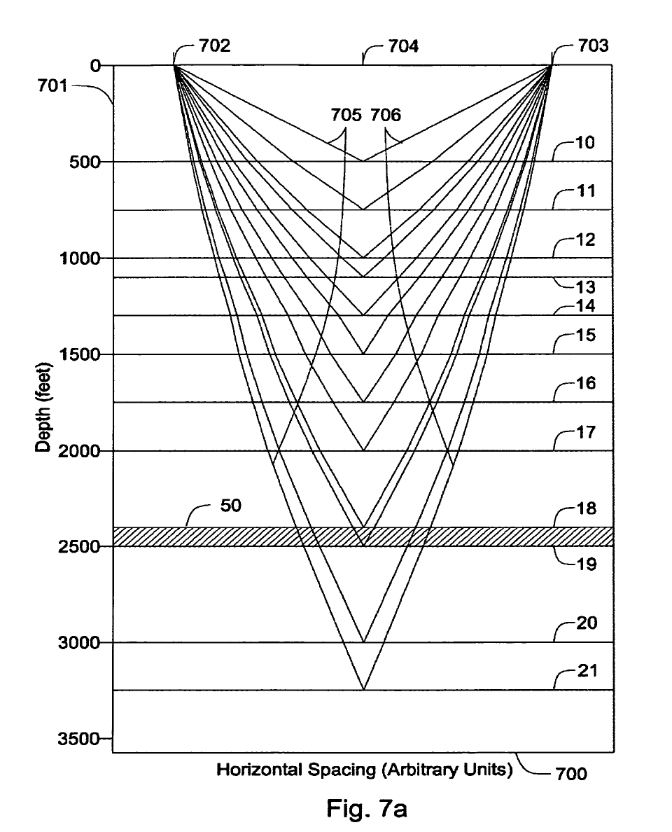

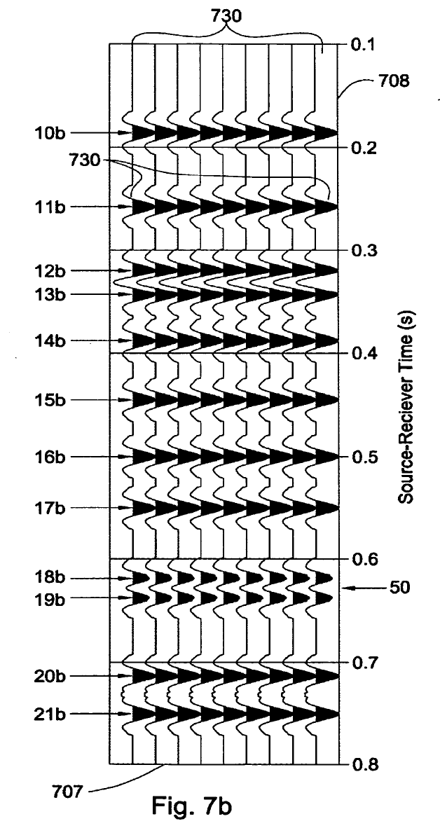

FIGS. 7 through 15 illustrate how the reflector arrival times of steps 503 and 507 and the subsurface models of steps 504 and 508 of FIG. 5 are created from recorded receiver waveforms obtained according to the invention at successive seismic MWD levels. FIG. 7a illustrates, for a single source and receiver, how seismic waves travel through the earth model of FIG. 6. The horizontal axis 700 represents horizontal source-to-receiver spacing, in arbitrary units; the vertical axis 701 represents depth in the earth. Reflectors 10 through 21 retain their meaning from FIG. 6. Location 702 represents the position of a seismic source at or near the surface of the earth; location 703 represents the location of a receiver, and location 704 represents the midpoint between the source and the receiver. Lines 705 represent the movement of seismic wave through the earth from the source to a reflector, and lines 706 represent movement of waves from a reflector to the receiver. Each of the twelve lines 705 together with its associated line 706 represents a complete ray path from source to reflector to receiver. Although seismic waves travel in a straight line between reflectors, they are bent or refracted at each reflector, due to the changes in seismic velocity presented in FIG. 6. In a typical surface acquisition a source would be recorded by not one, but by many receivers spaced at various distances and directions from the source. A surface seismic survey consists of many such source positions and their associated receivers. It is readily apparent that a large amount of information is required to accurately represent the received waveforms, especially when multiple receivers are involved. This presents little problem for surface seismic surveys, but it has hitherto been impossible for borehole seismic surveys made while drilling. Processing algorithms, well known to the art of seismic processing, are used to convert the acquired surface seismic data to an ideal data acquisition that consists of a set of ideal, co-located sources and receivers at a regular set of points on the surface of the earth. FIG. 7b models the result of this processing. The horizontal axis 707 is the horizontal position of the midpoint between the source and the receiver, in arbitrary units; the vertical axis 708 is recorded time, in seconds. The traces 730 represent nine ideal recorded amplitudes for nine co-located source-receiver pairs (called CDPs.) It is customary in seismic processing to fill in the wavelets 731 so as to facilitate visual identification of events and to spot alignments and trends. Thus the filled-in series of wavelets 731 show a horizontal event 11b. The correlation between the twelve reflectors 10 through 21 in the earth model with the twelve time of arrival events 10b through 21b is indicated by the lines connecting the respective elements between FIG. 7a and FIG. 7b.

The target zone 50 for a representative drilling program lies, in depth, between reflectors 18 and 19 of FIG. 7a. The depth is modeled here, for purposes of simulating the seismic waveforms of FIG. 7b, but in the real world it is not yet known. In time, the target zone 50 lies between events 18b and 19b of FIG. 7b. The surface seismic measurements exemplified in FIG. 7b establish only how long it takes a sound wave to travel from the earth, to the location of the reserves and back to the surface. If the velocity of sound in each rock layer were known then it would be a simple matter to determine the depth. The subsequent figures show how the seismic MWD apparatus and method of the present invention enable provision of velocity information and the time-to-depth tie and as the well is drilled.

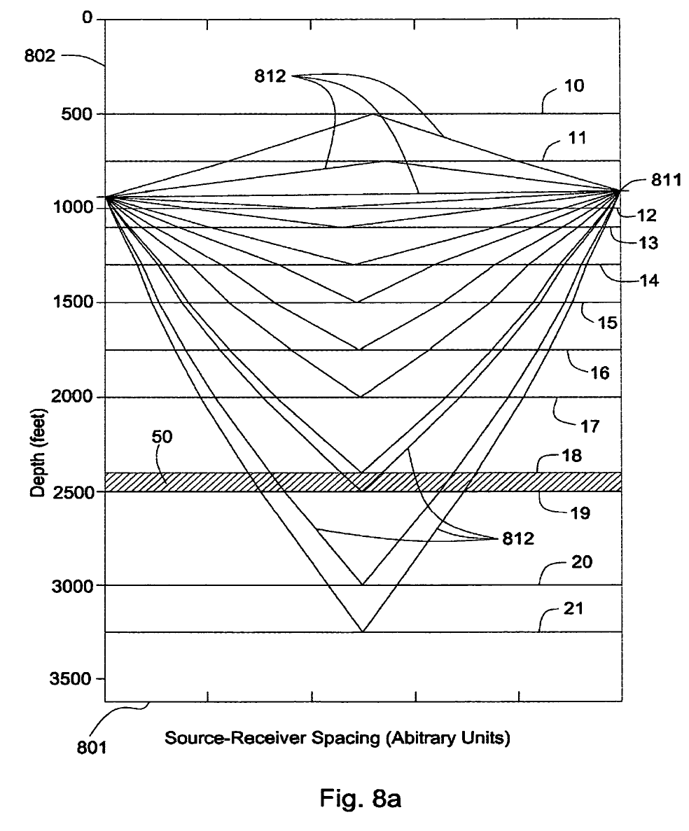

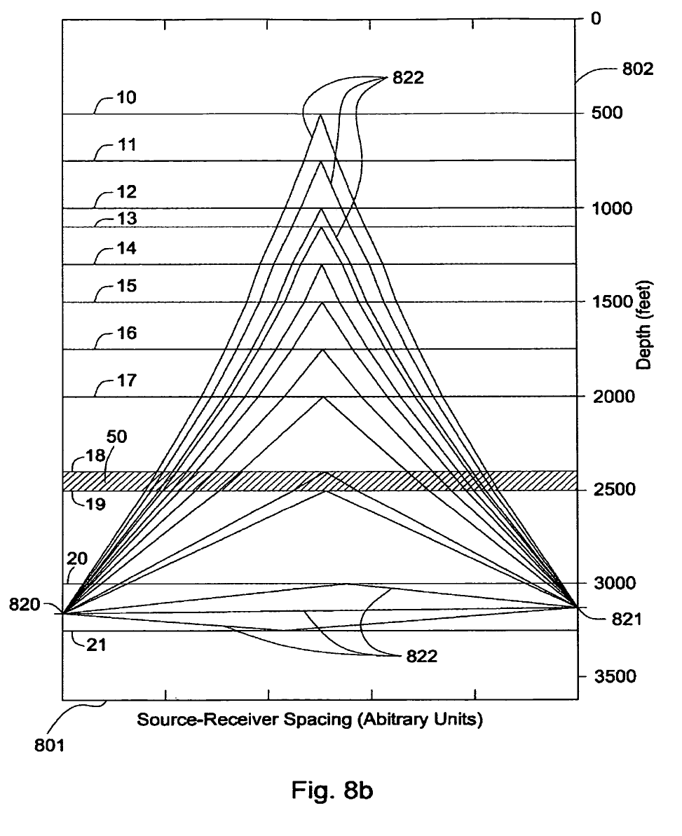

FIG. 8a shows the same earth model as FIG. 6 and FIG. 7a, with thirteen seismic ray path sets 812 generated according to Example 1 of the present invention when the source and receiver are positioned relatively close to each other and have progressed to an average shallow depth of about 900 ft. FIG. 8b shows the ray paths 822 when the source and receiver are at an average depth of about 3100 ft. Reflectors 10 through 21 retain the same identification as in FIGS. 6 and 7a, as does target zone 50. Depth is indicated by vertical axes 802. An important feature of this preferred source-receiver geometry is that it allows the detection of waves from above the source-receiver pair as well as from below, whereas the geometry of a conventional VSP wireline seismic acquisition allows only the detection of reflectors that are below the receiver. The horizontal distance between source and receiver, in arbitrary units, is shown on the horizontal axes 801. In FIG. 8a, the position of the source is indicated by 810, and the position of the receiver is indicated by 811. In FIG. 8b, the source position is 820; the receiver position is 821. The direct arrivals are represented by the straight ray paths between points 810 and 811 and points 820 and 821, respectively. The horizontal separation in a vertical well would normally be very small; here it is exaggerated to illustrate the paths of the seismic waves.

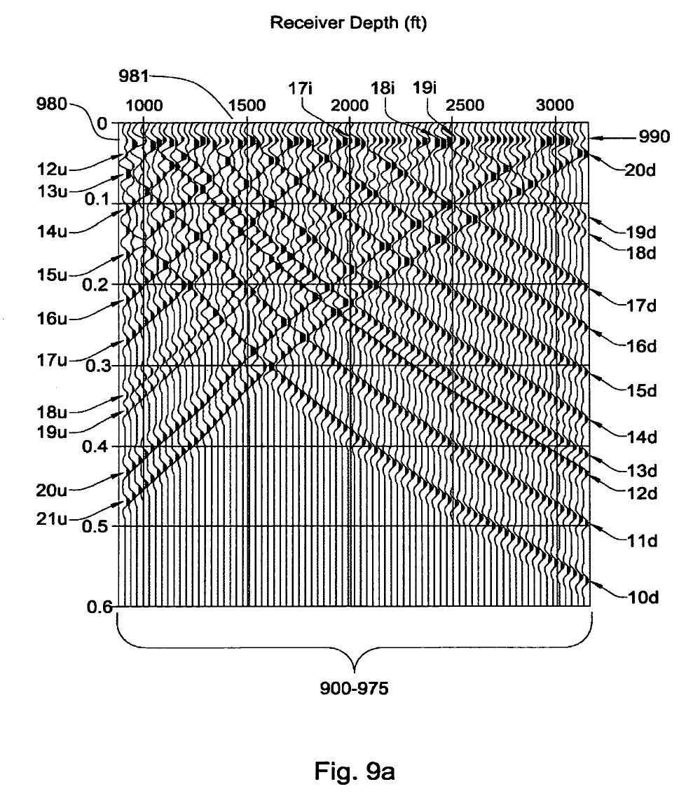

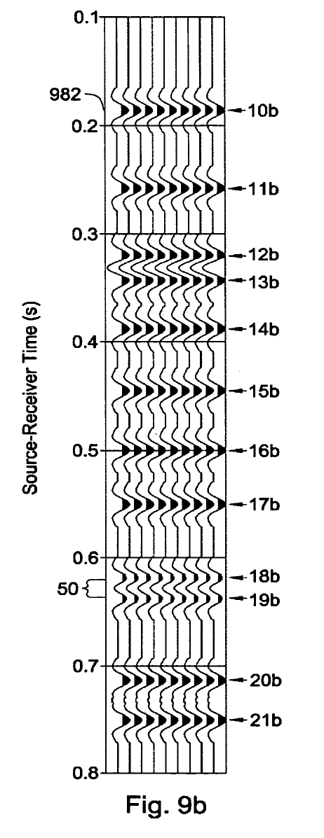

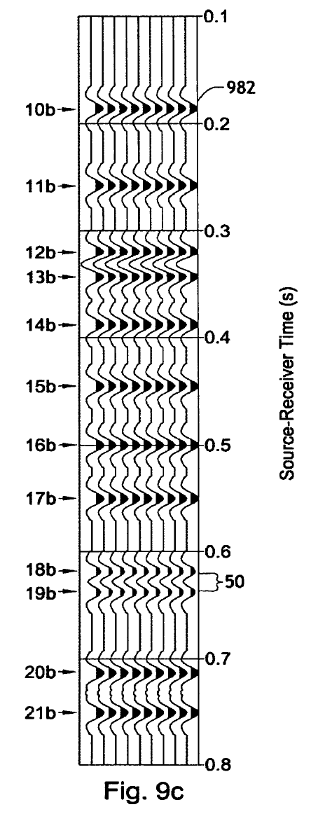

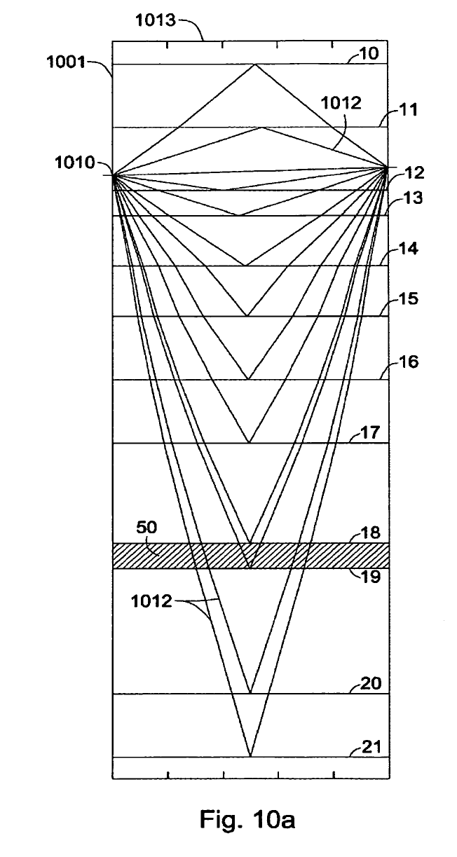

FIG. 9a shows a simulation of the received waveform data recorded for the geometry of Example 1 for multiple seismic levels taken over a complete seismic MWD drilling program conducted according to the preferred embodiment of Example 1. The vertical axis 980 is the recorded time. However, the horizontal axis 981 in this figure is now the depth of the receiver, which is known and recorded at the surface as each seismic level is taken. Each of the seventy-five vertical traces 900-975 represent a waveform or stack of waveforms recorded at a single seismic level, with each level about 30 feet (approximately one pipe length) below the previous level. Although seismic levels according to the present invention can be taken at any arbitrary spacing, it is preferred to take each level immediately before or after an additional joint is added, so as to minimize disruption of the drilling program. Trace 900, at the far left of FIG. 9a, is the recording corresponding to the eleven lower ray traces 812 (including the direct arrival) of FIG. 8a, taken at a depth of about 900 feet. The vertical trace 975, on the far right of FIG. 9a, is the recording corresponding to the twelve upper ray traces for the deeper depth of FIG. 8b (including the direct arrival), taken at about 3100 ft. FIG. 9b and FIG. 9c are the simulated data for surface acquisition, repeated for reference from FIG. 7b.

The events 12u through 21u, identified at the left side of FIG. 9a, are sloping upward to the right with increasing receiver depth. These represent upward-traveling energy from reflections from below the receiver, since the arrival times of these events are decreasing as the source-receiver pair gets deeper, i.e. the source-receiver pair is getting closer to the reflector. For example, the arrival time from reflector 21, shown as borehole seismic event 21u, decreases from about 0.48 seconds when the receiver is at a depth of about 900 feet (trace 900) to about 0.04 seconds when the receiver is at a depth of about 3100 ft. (trace 975). The events 10d through 20d, identified at the right side of FIG. 9a, are dipping down to the right with increasing receiver depth. These represent downward-traveling energy from reflections from above, since the arrival times of these events are increasing as the source-receiver pair gets deeper, i.e. the source-receiver pair is getting farther from the reflector. The reflections from above are called down-going since the waves arrive at the receivers moving downward, while the reflections from below are called up-going since the waves arrive at the receivers moving upward. Note that at the left side of FIG. 9a there are no upward-trending events from reflectors 10 and 11, because the seismic MWD program commenced at a depth below these reflectors, but the downward-trending events from reflectors 10 and 11 are clearly in evidence as events 10d and 11d at the right side of FIG. 9a.

Lines are drawn between FIG. 9b and FIG. 9a to connect the surface seismic events 12b through 21b with the borehole seismic events 12u through 21u, respectively, and lines are drawn between FIG. 9a and FIG. 9c to connect the borehole seismic events 10d through 20d with surface seismic events 10b through 20b. Notice that the reflections from above in the subsurface model of FIG. 9a of the invention are inverted in time from the same events recorded from the surface in FIG. 9c.

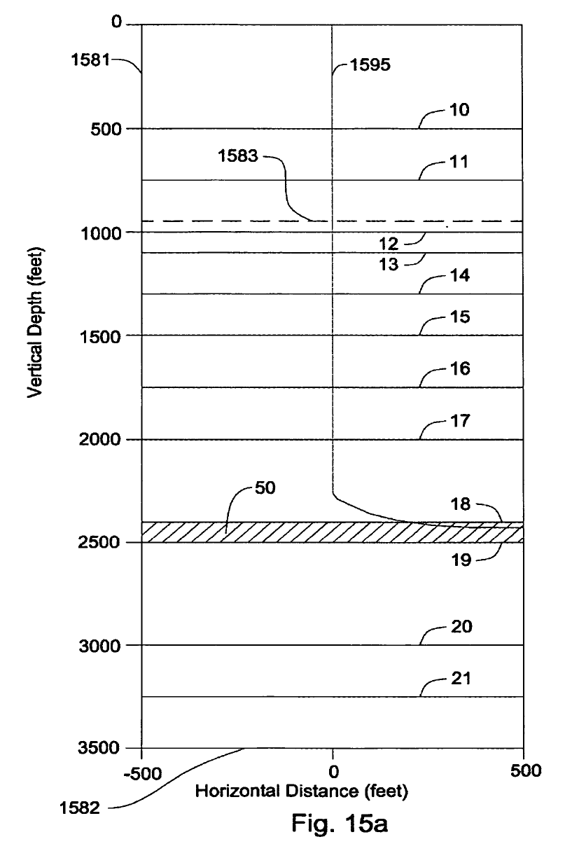

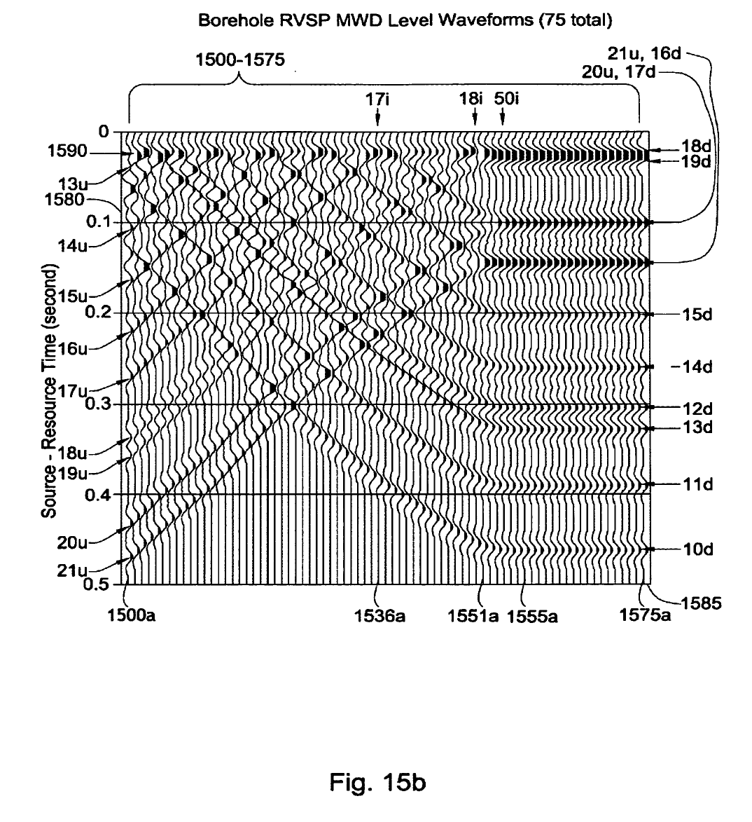

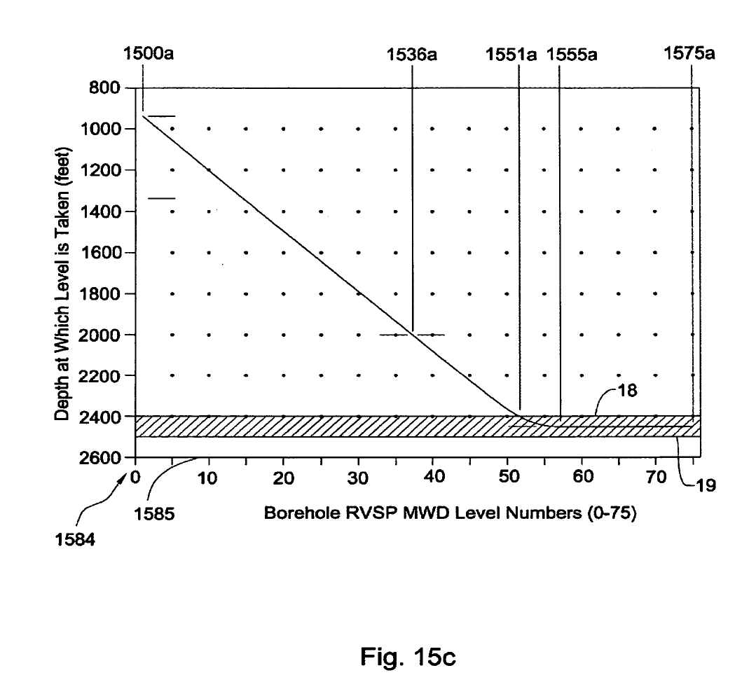

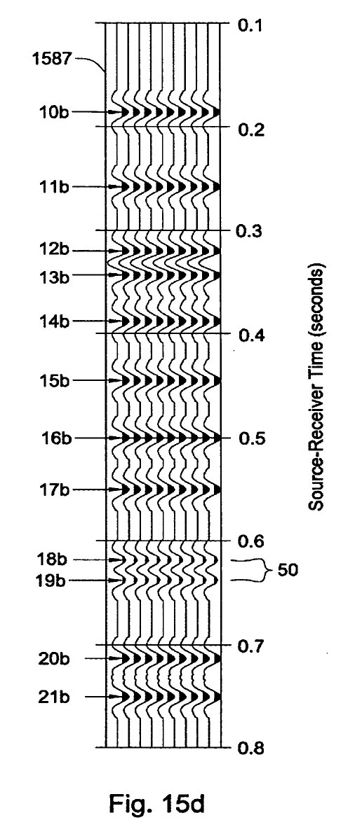

The horizontal event 990 near the top of FIG. 9a, called the direct arrival, is the seismic wave that travels directly from the source to the receiver. This event (and possibly its multiples) will have the largest amplitudes of any event. For illustration purposes any multiple events were suppressed in the modeling. The time of this event can be used to calculate the seismic velocity in the rock layer. (In the figure the data have been moved in time to clearly show the direct arrival.) As long as the source-receiver pair is above a reflector the reflection is from below. As the source-receiver pair gets closer to the reflector the time of reflection decreases until the source crosses the reflector. At this point the reflection disappears until both the source and the receiver are below the reflector. The reflection then changes to a reflection from above. Therefore the intersection of reflections from above and below at the direct arrival occurs at the depth of the reflector. FIG. 9a allows the tie of time to depth to be determined. For example, there is an intersection 18i of reflections 18u from below and 18d from above at about 2400 ft. that corresponds to event 18b in the surface seismic at about 0.61 seconds. This reflector is near the top of the target zone 50. Similarly, the intersection 19i of events 19u from below and 19d from above at about 2500 feet corresponds to event 19b from the surface seismic, at about 0.63 seconds. In this example the driller has drilled vertically through the target zone. In an actual drilling program, which will be presented in FIGS. 15a, 15b, and 15c, the intersection 17i at about 2,000 ft, corresponding to reflector 17, would have signaled the approach of reflector 18, and the bit could have been steered horizontally through the target zone between reflectors 18 and 19.

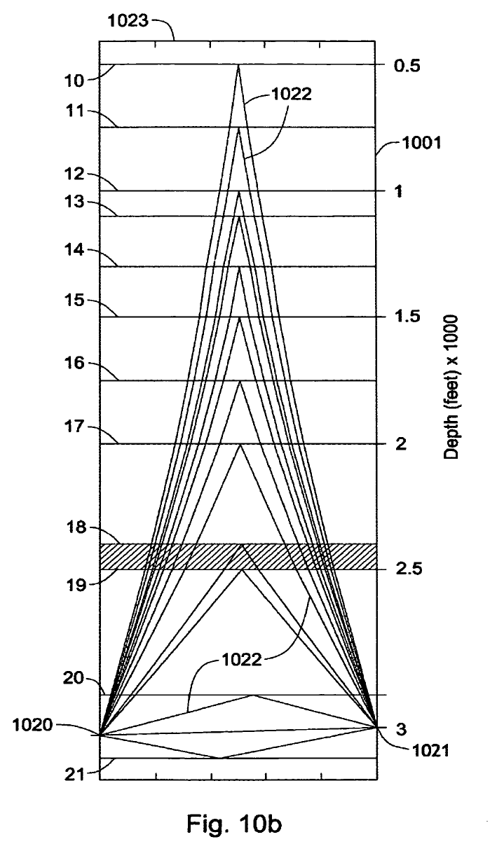

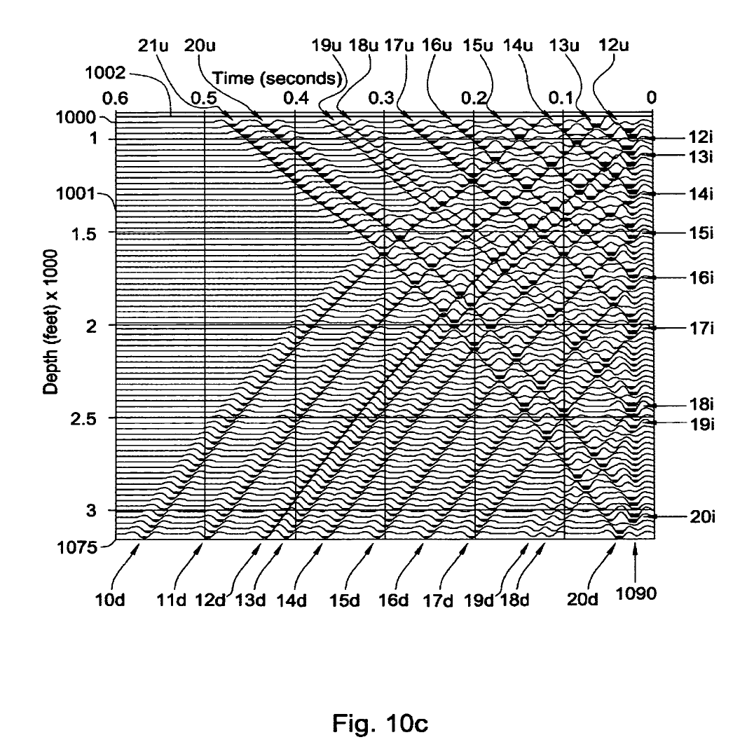

The tie of time to depth is emphasized in FIG. 10c, which correlates the waveforms from FIG. 9a with the ray paths from FIGS. 8a and 8b. FIG. 10a repeats the ray paths of FIG. 8a, and FIG. 10b repeats the ray paths of FIG. 8b, with compression of the arbitrary horizontal axes 1013 and 1023. FIG. 10c presents the simulated VSP-while-drilling data after rotation of the axes, so that the vertical axis 1001 is now depth. Axis 1001 is aligned in depth for FIGS. 10a, 10b, and 10c. The position of the source in FIG. 10a is 1010; the position of the receiver is 1011. The position of source in FIG. 10b is 1020; the position of the receiver is 1021. The eleven lower ray traces 1012 between source and receiver in FIG. 10a correspond to the wave trace 1000 from the first seismic level of FIG. 10c, and the twelve upper ray traces 1022 of FIG. 10b correspond to the wave trace 1075 from the last seismic level of FIG. 10c. (Wave traces 1000 through 1075 of FIG. 10c correspond to traces 900 through 975, respectively, of FIG. 9a). The reflectors 10 through 21 of FIGS. 10a and 10b retain their meaning from FIG. 6, as does target zone 50.

The horizontal axis 1002 of FIG. 10c represents the travel time for seismic waves from source to receiver, in seconds, with zero at the right. The events marked 12u through 21u represent upward-traveling energy from reflectors 12 through 21, respectively, when these reflectors are below the source-receiver pair. The events marked 10d through 20d represent downward-traveling energy from reflectors 10 through 20 when these reflectors are above the source-receiver pair. The subset of events 12u through 20u intersect with events 12d through 20d at the direct arrival trace 1090. These intersections of upward- and downward-going energy are labeled 12i through 20i and line up directly with reflectors 12 through 20 of the earth models of FIGS. 10a and 10b. The depths of the intersections 12i through 20i can now be read directly from the depth axis 1001.

It is now clearly seen that the two top reflectors 10 and 11 have depths shallower than the first level taken during the seismic MWD program and thus are recorded only as down-going energy events 10d and 11d. The bottom reflector 21 is below the lowest level of the seismic MWD program and accordingly is recorded only as upward-going energy event 21u. The time-to-depth tie for the reflectors outside the acquisition region must be extrapolated from the data. However the extrapolation will become more and more accurate as the drill bit gets closer and closer to the reflector. Since the data will be processed as the drilling continues, the prediction can be done in real time and can be refined as the drill approaches the target.

The data received according to the invention can be processed to provide an image that can be compared to the seismic section using well-known VSP processing techniques. First the direct arrival (and multiples thereof) have to be removed. A standard technique for the removal of direct arrivals and multiples is to pick the direct arrival. The direct arrival may be hand picked from a display of the data or by using other procedures known to the art. The picks are used to align the direct arrival at a specific time and the direct arrival is removed using a median filter. These picks can also be used to derive the velocity in the rock layers. Since the direct arrivals, which usually have large amplitude, have been suppressed in the modeling, this step is not necessary for this data set.

Next the data can be separated into up-going and down-going events by known means such as FK and median filtering. Median filtering is used on the data of FIG. 9a, which was modeled according to the embodiment of Example 1 in the earth model of FIG. 6. The data are picked by choosing any event or even a sequence of events that completely cross the data set. The picks are used to align the data and then a median filter is applied to enhance the aligned events. The time reversal of the reflections from above can be corrected by performing a time reversal on the median filtered data. The same pick can be used for both the up- and down-going data. The only difference is the direction of application. To see this consider two subsequent levels or source-receiver positions. A certain time is recorded for both the up- and down- going waves for the shallower position. The time recorded for the deeper position is slightly longer for the down going wave and slightly shorter for the up going wave. In either case the time increment or decrement is the sum of the time required for sound to travel between the two source positions plus the time required for sound to travel between the two receiver positions. This time interval is the same for all events; thus if the deeper position is shifted up by this time, the down-going events will line up, while if the deeper position is shifted down by this time, the up-going events will line up. The picks for up- and down-going separation can also be derived from the direct arrival picks if the depth interval for data acquisition is the same as the source-receiver separation.

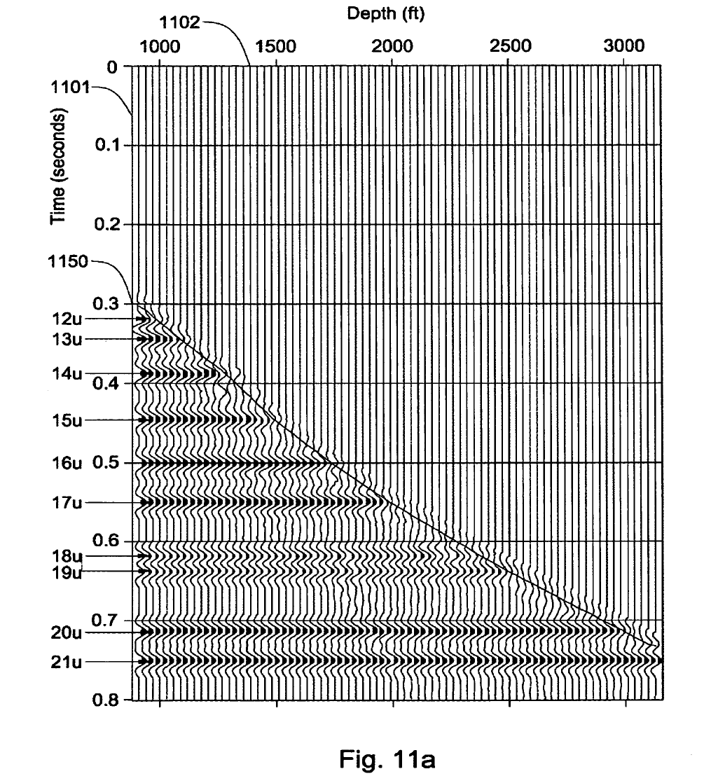

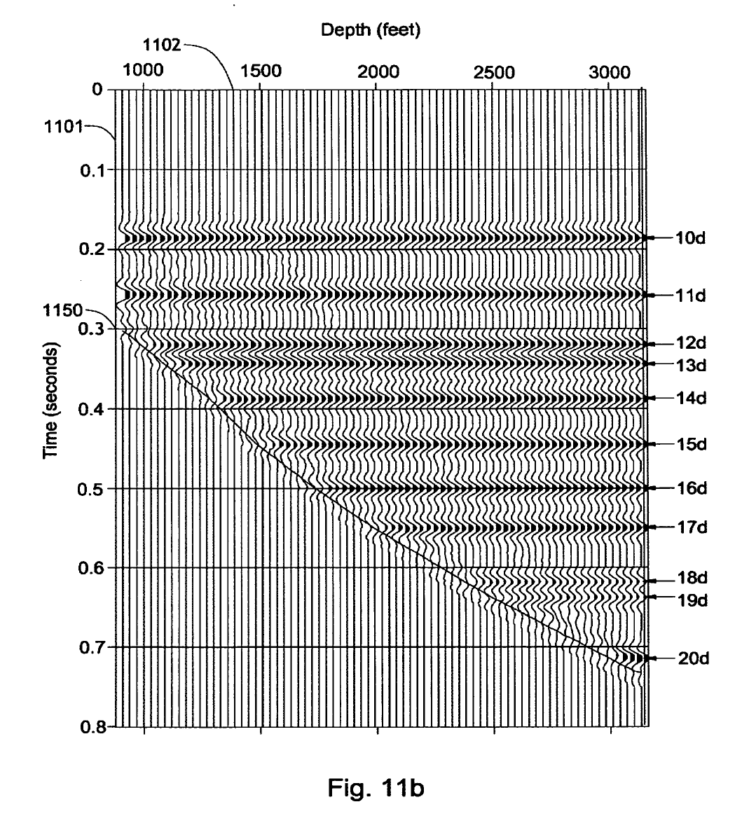

FIG. 11a and FIG. 11b show the result of the processing. FIG. 11a presents the up-going data of FIG. 9a, and FIG. 11b presents the down-going data. The data have also undergone additional shifts for time alignment with the surface seismic data. Line 1150 is the time-to-depth curve used to shift the data. Up-going events 12u through 21u of FIG. 11a and down-going events 10d through 20d of FIG. 11b retain their meanings from FIG. 9a.

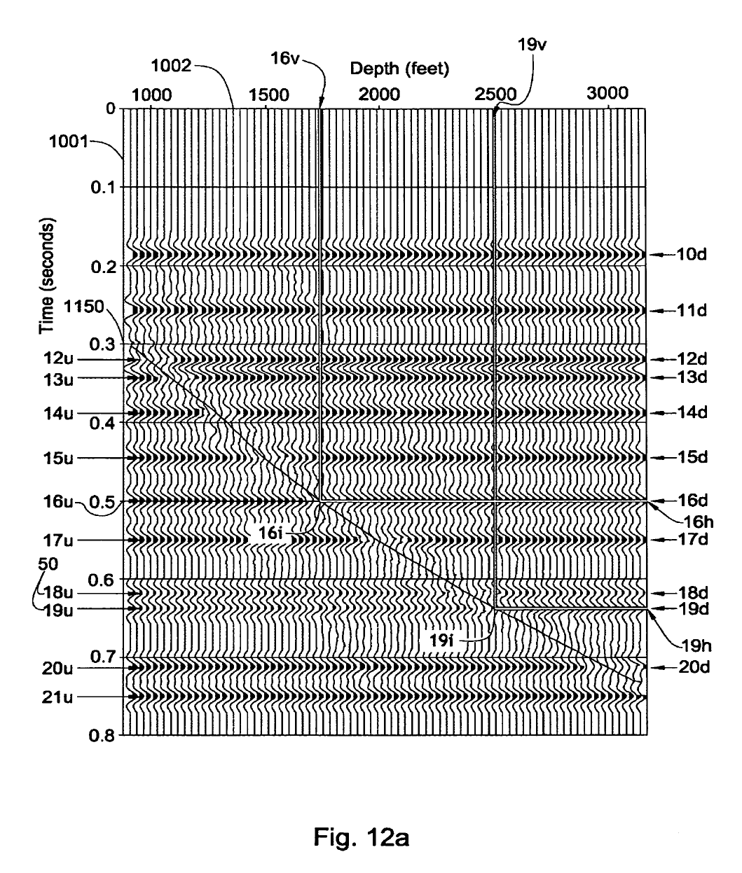

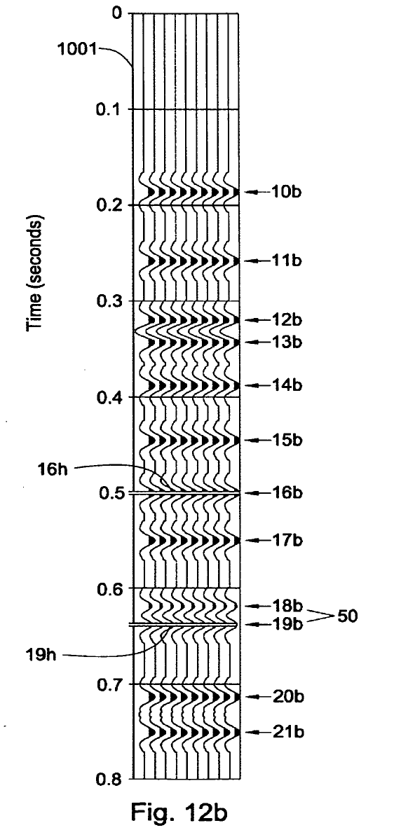

FIG. 12a is the “stack” of the up-going and down-going data from FIGS. 11a and 11b; derived from pair-wise summing of the corresponding traces in each data set. FIG. 12b repeats the surface seismic data of FIG. 7b for reference. The vertical axis 1101 is the event time, in seconds, normalized to the surface seismic survey; horizontal axis 1102 is the depth of the seismic level, in feet. Line 1150 of FIG. 12a is the time-to-depth curve. The borehole seismic events now line up horizontally with the surface seismic data, giving direct identification. The true depth of any surface seismic event can now be determined by drawing a horizontal line from the event in FIG. 12b to the point of intersection of the time-to-depth tie 1150 of FIG. 12a. At the intersection point a line is drawn vertically to intersect the depth axis 1102, thereby establishing the depth of the seismic event. Thus line 16h, drawn horizontally from surface seismic event 16b and coinciding with seismic MWD events 16d and 16u, intersects the time-to-depth curve 1150 at point 16i. Vertical line 16v drawn from this point intersects axis 1102 at a depth of about 1750 feet. In similar fashion, line 19h, drawn horizontally from surface seismic event 19b and coinciding with borehole seismic MWD events 19d and 19u, intersects curve 1150 at point 19i. Vertical line. 19v intersects axis 1102 at a depth of about 2,500 feet. The true depth of the reflector 19 at the bottom of the target zone 50 is thereby established. This procedure can be extended to seismic events which have not yet been drilled by projecting the time-to-depth curve beyond the drill bit. The intersection of the seismic event with the projected time-to-depth curve gives an estimate of the depth of the seismic event.

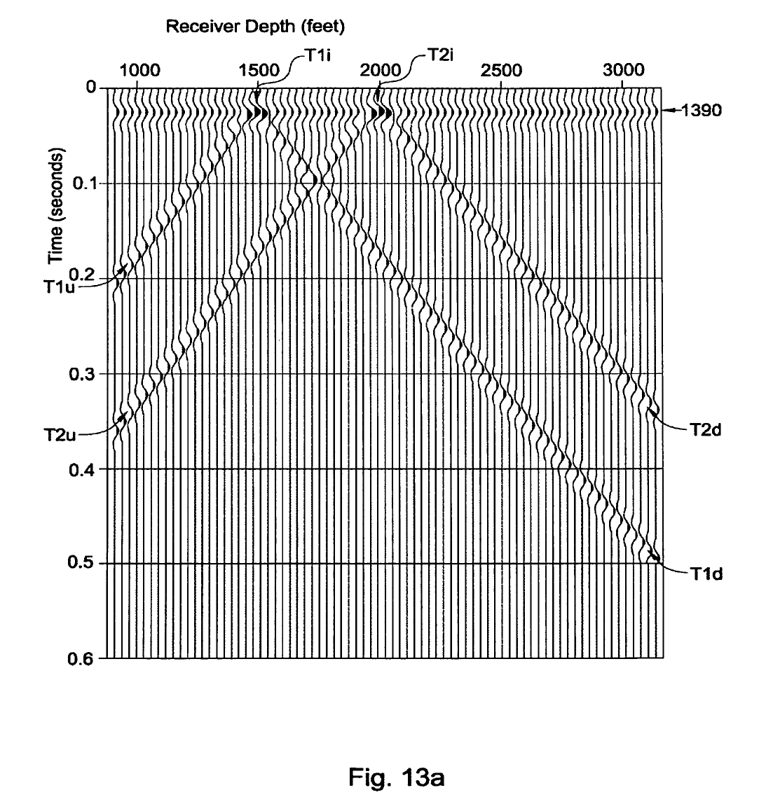

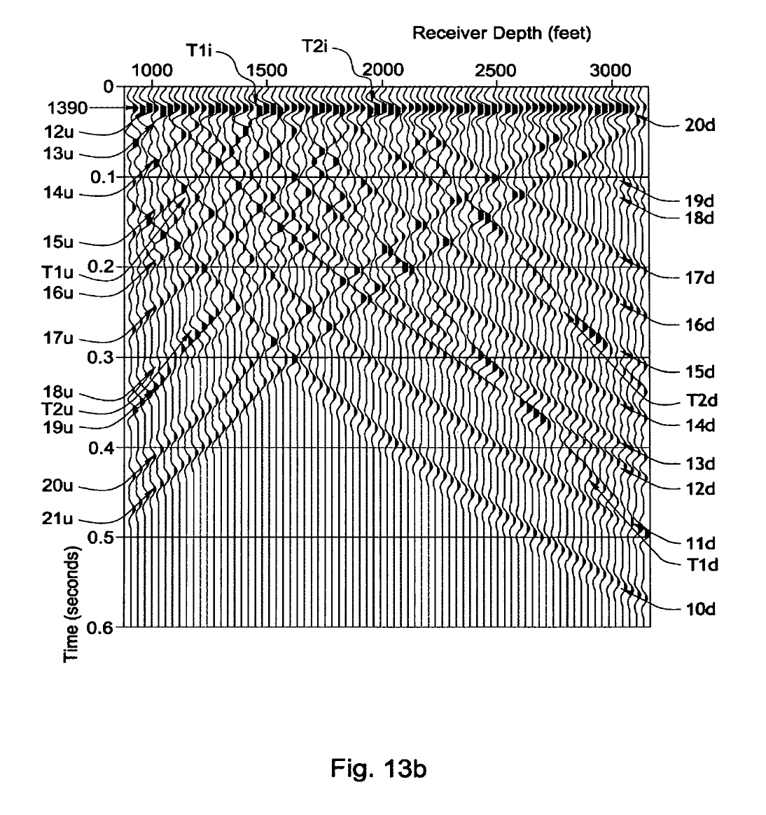

FIG. 13a and FIG. 13b show the effect of tube waves on the seismic analysis. Tube waves are a type of guided wave that moves through the borehole fluid. Tube wave velocities depend on the type of fluid in the bore hole and the shear wave velocity of the formation. A typical tube wave velocity is 4500 feet per second, compared to a typical p-wave velocity in rock ranging from 5,000 to 20,000 feet per second. In addition to direct arrivals, tube waves can be reflected at geological interfaces, abrupt changes in the diameter of the hole, or joints in the drill string. They can also be generated by a body wave in the earth that interacts with a geological interface (reflector). The latter source of tube waves can be used just like a body wave to identify the depth of an interface. FIG. 13a shows the direct tube wave 1390, a body wave T1i converted into tube waves T1u and T1d at 1500 feet, and a body wave T2i converted into tube waves T2u and T2d at 2000 ft. Notice that unlike the reflected body wave that produces curved events because of the velocity changes in individual layers, tube waves are nearly linear events because they travel with a nearly constant velocity in the well bore. This is indicated by the straight white lines superimposed on the up-going events T1u and T2u and on the down-going events T1d and T2d. In FIG. 13b the tube waves of FIG. 13a are superimposed on the body waves of FIG. 9a, showing how the tube wave would appear in actual data. The tube wave direct arrival 1390 has broadened the direct arrival (element 990 of FIG. 9a) and increased its amplitude. Without the white lines manually superimposed on the tube waves T1u, T1d, T2u, and T2d it would be almost impossible to sort the tube waves from the body waves. Note that tube wave T2u of FIG. 13b interferes with body waves 19u and 18u, and that tube wave T1d either crosses or interferes with body waves 11d through 15d. The amplitude of the tube waves can range from much larger than the body waves to much smaller than the body waves. The uncertainty of the origin of the tube wave, combined with their often high amplitude, may either hinder or enhance the identification of interfaces between rock layers. Although there are known analytical processes for recognizing and reducing the interference from tube waves, it is preferred in the present invention to minimize the effect of tube waves by employing tube wave suppression devices in the borehole, as illustrated by element 114 of FIG. 1, element 214 of FIG. 2, and elements 314, 324, and 334 of FIG. 3.

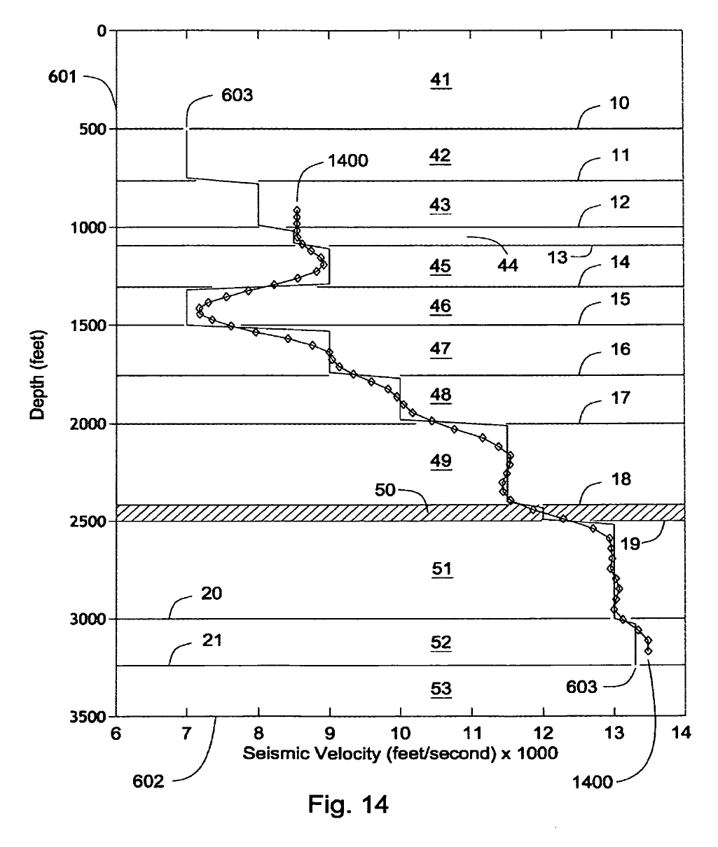

Hydrocarbons are frequently found in regions of abnormal pressures. Knowledge of the pressure distribution is of importance for the prediction and protection of reserves, and for drilling safety. A seismic expression of overpressure is a decrease in the expected rock velocity. Because of compaction the normal trend is an increase in seismic velocity with depth. Over-pressured zones show a decrease in seismic velocity with depth. FIG. 14 repeats the earth velocity model of FIG. 6 and compares the velocity curve 603 that is used in the modeling with the velocity curve 1400 derived from the time-depth curve 1150 of FIG. 12a. (Elements 10 through 21, 41 through 53, and 601 through 603 retain their meaning from FIG. 6). There is a good agreement between curve 603 and curve 1400, and the agreement can be improved by taking seismic levels at closer intervals. Velocity curve 1400 can be developed in real time from the time-depth curve as the drilling progresses, thereby giving advance warning of unsafe or unstable conditions. In addition, the time-depth curve can be extended ahead of the bit in regions which have not been drilled by using full wave form inversion techniques known in the art.

FIG. 15a, FIG. 15b, FIG. 15c, and FIG. 15d illustrate how a borehole seismic MWD program conducted according to the preferred embodiment of Example 1 and the method flow chart of FIG. 5 enables the borehole to be directed into a horizontal target and guided to remain within that target. FIG. 15a shows the planned well trajectory 1595. Prior to drilling, it is known that the target zone 50 lies between reflectors 18 and 19, but the actual depth of the reflectors, as represented on vertical axis 1581, is not known in advance and is obtained only as the borehole seismic MWD program progresses. The planned horizontal displacement of the bit is given by horizontal axis 1582. The seismic MWD program begins at the depth indicated by dashed line 1583, at approximately 950 feet. Reflectors 10 through 21 retain their identities from FIG. 6.

FIG. 15b presents seventy-five simulated borehole seismic waveforms 1500 through 1575. The seventy-five seismic levels that generate these waveforms are taken with the drill string geometry of FIG. 1 at approximately equal separation along the trajectory 1595. FIG. 15c plots the depth of each level, which is obtained from actual bit depth as the well progresses. To obtain the depth of a seismic level from the graph, the level number (0 through 75) is found along the horizontal axis 1585, which is identical for FIGS. 15b and 15c. A vertical line is drawn to intersect line 1596, and the depth of the seismic level is read off the vertical axis 1584. Thus line 1500a identifies the first seismic level waveform 1500, taken at a depth of approximately 950 feet.

As the well progresses in the vertical section, up-going events 13u through 21u can be traced through the waveforms moving upward to the right from time axis 1580 of FIG. 15b. As the borehole progresses through each reflector, the event from that reflector intersects the direct arrival event 1590, and down-going events 10d through 19d are then generated. The intersection of up-going event 17u and down-going event 17d with the direct arrival 1590 at point 17i occurs at seismic level 1536; the intersection of line 1536a with line 1596 of FIG. 15c is at a depth of about 2000 ft. This event signals the approach of the target zone 50, and the driller begins a gradual change in direction of the borehole from vertical toward horizontal. The driller continues taking a seismic level as each drill pipe is added to the string and monitors the approach of event 18u to the direct arrival event 1590. As the borehole crosses the reflector 18 at seismic level 1551, it can be seen that line 1551a intersects line 1596 at a depth of about 2400 feet. The intersection of up-going event 18u with direct arrival event 1590 is indicated by point 18i. The driller continues a gradual drift downward through target zone 50 until the bit is at the midpoint of the target zone, half-way between reflectors 18 and 19. This occurs at seismic level 1555, shown by the intersection of line 1555a with line 1596 at a depth of about 2450 feet. Point 50i represents the intersection of the approximate mid-point of overlapping events 18d and 19u with the direct arrival 1590. At the seismic frequencies used for this particular simulation, the wavelets 18d, from reflector 18 above the bit, and 19u, from reflector 19 below the bit, overlap somewhat. The driller continues to steer the bit between reflectors 18 and 19 until the final seismic level 1575, resulting in a horizontal borehole that lies within the target zone for a distance of approximately 400 feet.

As the bit approaches the target zone 50, the seismic source can be swept at increasingly higher frequencies. This will result in shorter wavelengths for seismic body waves. The overlapping of wavelets 18d and 19u can thus be avoided, and geosteering will occur with greater precision. Higher source frequencies, even approaching the sonic range of up to a few kHz, can also provide additional information about porosity and pore pressure in the target zone, thereby allowing the driller to change drilling conditions and steer the bit so as to enhance reservoir preservation and increase resource recovery. Higher source frequencies are usually coupled with decreased range for seismic body waves. However, the distant horizons, once needed for identification of the approaching target zone, are now of less interest than maintaining a precise elevation within the target zone. In the upper portion of the borehole, a sweep over frequency range of about 4 Hz to about 120 Hz is preferred so as to acquire distant reflectors. As the borehole approaches the target or is steered within the target, a sweep over a frequency range of about 50 Hz to about 2,000 Hz is preferred so as to pin-point nearby reflectors and obtain additional information about the target formation.

FIG. 15d repeats the surface seismic waveforms of FIG. 7a to allow correlation of the borehole seismic events with the surface measurements; compare with FIG. 9c. By happenstance, events 20u and 17d overlap during the horizontal portion of the drilling program, as do events 21u and 16d. Reference to FIG. 15a shows that the overlapping reflectors 17 and 20 are approximately equidistant from the horizontal portion of borehole trajectory 1595, as are reflectors 16 and 21. In this simplified simulation, all the reflectors are horizontal, and so the events 10d through 18d, together with events 19u through 21u, continue parallel to the target events 18d and 19u. Since the borehole remains above reflectors 19, 20 and 21, there are no down-going events from these reflectors.

It can thus be seen that the embodiments of apparatus and method of the present invention enable a seismic MWD program that facilitates identification of the target horizon while drilling in a near-vertical section of the well, together with directional geosteering of the bit to position the borehole precisely within a near-horizontal target zone.

1. A method for seismic measurement-while-drilling, comprising: providing a downhole seismic source and providing a downhole seismic receiver in a drill string; the source and receiver being fixed at a pre-determined distance from each other; producing a model characteristic of the subterranean formation by performing a first seismic shot at a first feqeuncy at a first level as drilling progresses into a subterranean formation producing at least a second model that is characteristic of the subterranean formation by performing at least one subsequent seismic shot of a higher frequency at at least one subsequent level,; using the first and at least the second model in combination to evaluate the subterranean formation and to evaluate the progress of the drill string relative to the formation.

2. The method of claim 1, wherein the drill string further comprises an integrated downhole data transmission network.

3. The method of claim 2, wherein a pilot signal representative of the source is transmitted in real time to the surface over the downhole network.

4. The method of claim 2, wherein waveforms detected by the receiver are transmitted in real time to the surface over the downhole network.

5. The method of claim 2, wherein the source and the receiver are synchronized by means of the downhole network.

6. The method of claim 2, wherein at least one of the source or the receiver is actuated or controlled by means of the downhole network.

7. The method of claim 2, wherein the transmission network comprises inductive couplers located in the tool joints.

8. The method of claim 7, wherein the inductive couplers comprise magnetically-conductive, electrically-insulating material.

9. The method of claim 8, wherein the magnetically-conductive, electrically-insulating material comprises a ferrite.

10. The method of claim 2, wherein the transmission network comprises couplers comprising direct electrical contacts.

11. The method of claim 2, wherein the transmission network is capable of transmitting power.

12. The method of claim 1, wherein the seismic source is selected from the group consisting of a mud hammer, a mud siren, a jar, a piezoelectric source, a magnetostrictive source, a device incorporating an eccentric rotor, and a drill bit.

13. The method of claim 1, wherein the seismic source produces a characteristic wave such that the source signal is differentiated from noise generated by the drill string.

14. The method of claim 1, wherein the seismic receiver comprises a sensor selected from the group consisting of a geophone, a hydrophone, and an accelerometer.

15. The method of claim 1, wherein the seismic receiver is positioned against the borehole wall.

16. The method of claim 1, wherein a tube wave suppression device is located in the drill string.

17. The method of claim 1, wherein a seismic level is obtained when circulation and rotation have ceased.

18. The method of claim 1, wherein a seismic level is obtained when rotation has ceased.

19. The method of claim 1, wherein a seismic level is obtained while actively drilling ahead.

20. A method for seismic measurement-while-drilling, comprising: providing a downhole hammer serving as a seismic source and a downhole seismic receiver on a downhole data transmission network integrated into a drill string; the hammer and receiver being fixed at a pre-determined distance from each other within the dr ill string; producing a model characteristic of the subterranean formation by performing a first siesmic shot at a first fequency at a first level as drilling progresses into a subterranean formation; and producing at least a second model that is characteristic of the subterranean formation by performing at least one subsequent seismic shot of a higher frequency at at least one subsequent level; and using the first and at least the second model in combination to evaluate the subterranean formation and to evaluate the progress of the drill string relative to the formation.

21. The method of claim 20, wherein a pilot signal representative of the impulses generated by the hammer is transmitted to the surface over the downhole network.

22. The method of claim 20, wherein waveforms detected by the receiver are transmitted to the surface over the downhole network.

23. The method of claim 20, wherein the hammer and the receiver are synchronized by means of the downhole network.

24. The method of claim 20, wherein at least one of the hammer or the receiver is actuated or controlled by means of the downhole network.

25. The method of claim 20, wherein the transmission network comprises inductive couplers.

26. The method of claim 25, wherein the inductive couplers comprises magnetically-conductive, electrically-insulating material.

27. The method of claim 26, wherein the magnetically-conductive, electrically-insulating material comprises a ferrite.

28. The method of claim 20, wherein the hammer produces a characteristic wave such that the source signal is differentiated from noise generated from the drill string.

29. The method of claim 20, wherein the hammer is operational while the drill string is actively drilling ahead.

30. The method of claim 20, wherein a tube wave suppression device is interposed between the hammer and the receiver.

31. A method for seismic measurement-while-drilling, comprising: providing a downhole seismic source and a downhole seismic receiver in a drill string, the source and receiver being fixed at a pre-determined distance form each other within the drill string; producing a model characteristic of the subterranean formation by a first seismic shot at a first fequency at a first level as drilling progresses into a subterranean formation, producing at least a second model that is characteristic of the subterranean formation by performing at least one subsequent seismic shot at a higher frequency at at least one subsequent level, and using the first and at least the second model in combination to evaluate the subterranean formation and to evaluate the progress of the drill string relative to the formation; wherein the drill string further comprises an integrated downhole transmission network capable of transmitting data in real time.

32. The method of claim 31, wherein the downhole seismic source is capable of of providing seismic impulses over a frequency range extending from about 4 Hz to about 2,000 Hz, the frequency range being controlled from the surface over the integrated downhole transmission network, wherein the source is swept over a lower portion of the frequency range in the upper portion of the borehole and is swept over and upper portion of the frequency range in the lower portion of the borehole.

33. The method of claim 32, wherein the frequency range used in the upper portion of the borehole is from about 4 Hz to about 150 Hz, and the frequency range used in the lower portion of the borehole is from about 50 Hz to about 2,000 Hz.

34. (canceled)

35. (canceled)

36. (canceled)
